(19) United States
(12) Patent Application Publication
(10) Pub. No.: US 2026/0253339 A1
(43) Pub. Date: Aug. 27, 2026

(54) TECHNIQUES FOR SEGMENTING MODELS

(71) Applicant: QUALCOMM Incorporated, San Diego, CA (US)

(72) Inventors: Satyam GABA, San Diego, CA (US); Lokesh JAIN, San Diego, CA (US); Parag Mohan KANADE, San Diego, CA (US); Sony AKKARAKARAN, Poway, CA (US); Tao LUO, San Diego, CA (US)

(21) Appl. No.: 19/547,421

(22) Filed: Feb. 23, 2026

Related U.S. Application Data
(60) Provisional application No. 63/763,749, filed on Feb. 26, 2025.

(51) Int. Cl. G06T 19/00; G06T 15/06; G06T 15/20; G06T 17/20

(52) U.S. Cl. CPC G06T 19/00; G06T 15/06; G06T 15/20; G06T 17/20; G06T 2219/004

(57) ABSTRACT

Methods, systems, and devices for wireless communications are described. A computer vision pipeline may be implemented that enables segmentation of 3D models. For example, multiple two-dimensional (2D) images may be generated from a three-dimensional (3D) model, and multiple image segmentation masks may be generated based on segmentation operations performed on each 2D image. Backprojection operations may be performed for each image segmentation mask, where a correspondence between respective pixels of each image segmentation mask and respective objects of the 3D model is identified in accordance with the backprojection operations. Further, sets of labels from each image segmentation mask may be merged based on the correspondence, and the respective objects may be associated with a label in accordance with the merging. A segmented 3D model may be generated that corresponds to the original three-dimensional model, where the segmented three-dimensional model includes the respective objects having an associated label.

### CROSS REFERENCES

The present application for patent claims benefit of U.S. Provisional Patent Application No. 63/763,749 by GABA et al., entitled “TECHNIQUES FOR SEGMENTING MESH MODELS,” filed Feb. 26, 2025, which is assigned to the assignee hereof, and expressly incorporated herein.

### FIELD OF TECHNOLOGY

The following relates to data processing, including techniques for segmenting models.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by an apparatus is described. The method may include obtaining a set of multiple two-dimensional (2D) images from a three-dimensional (3D) model, generating a set of multiple image segmentation masks based on one or more segmentation operations performed on each 2D image of the set of multiple 2D images, where respective objects of the set of multiple image segmentation masks are assigned one or more labels, performing backprojection operations for each image segmentation mask of the set of multiple image segmentation masks, where a correspondence between respective pixels in each image segmentation mask and respective objects of the 3D model is identified in accordance with the backprojection operations, merging sets of the one or more labels from each image segmentation mask of the set of multiple image segmentation masks based on the correspondence, where the respective objects of the 3D model are associated with a label in accordance with the merging, and generating a segmented 3D model that corresponds to the 3D model, the segmented 3D model including the respective objects of the 3D model having an associated label.

An apparatus is described. The apparatus may include one or more memories storing processor executable code, and one or more processors coupled with the one or more memories. The one or more processors may individually or collectively be operable to execute the code to cause the apparatus to obtain a set of multiple 2D images from a 3D model, generate a set of multiple image segmentation masks based on one or more segmentation operations performed on each 2D image of the set of multiple 2D images, where respective objects of the set of multiple image segmentation masks are assigned one or more labels, perform backprojection operations for each image segmentation mask of the set of multiple image segmentation masks, where a correspondence between respective pixels in each image segmentation mask and respective objects of the 3D model is identified in accordance with the backprojection operations, merging sets of the one or more labels from each image segmentation mask of the set of multiple image segmentation masks based at least in part on the correspondence, where the respective objects of the 3D model are associated with a label in accordance with the merging, and generate a segmented 3D model that corresponds to the 3D model, the segmented 3D model including the respective objects of the 3D model having an associated label.

Another apparatus is described. The apparatus may include means for obtaining a set of multiple 2D images from a 3D model, means for generating a set of multiple image segmentation masks based on one or more segmentation operations performed on each 2D image of the set of multiple 2D images, where respective objects of the set of multiple image segmentation masks are assigned one or more labels, means for performing backprojection operations for each image segmentation mask of the set of multiple image segmentation masks, where a correspondence between respective pixels in each image segmentation mask and respective objects of the 3D model is identified in accordance with the backprojection operations, means for merging sets of the one or more labels from each image segmentation mask of the set of multiple image segmentation masks based on the correspondence, where the respective objects of the 3D model are associated with a label in accordance with the merging, and means for generating a segmented 3D model that corresponds to the 3D model, the segmented 3D model including the respective objects of the 3D model having an associated label.

A non-transitory computer-readable medium storing code is described. The code may include instructions executable by one or more processors to obtain a set of multiple 2D images from a 3D model, generate a set of multiple image segmentation masks based on one or more segmentation operations performed on each 2D image of the set of multiple 2D images, where respective objects of the set of multiple image segmentation masks are assigned one or more labels, perform backprojection operations for each image segmentation mask of the set of multiple image segmentation masks, where a correspondence between respective pixels in each image segmentation mask and respective objects of the 3D model is identified in accordance with the backprojection operations, merging sets of the one or more labels from each image segmentation mask of the set of multiple image segmentation masks based at least in part on the correspondence, where the respective objects of the 3D model are associated with a label in accordance with the merging, and generate a segmented 3D model that corresponds to the 3D model, the segmented 3D model including the respective objects of the 3D model having an associated label.

Some examples of the method, apparatus, and non-transitory computer-readable medium described herein may further include operations, features, means, or instructions for generating a segmented 3D point cloud based on a set of associations between the respective pixels in each image segmentation mask and respective points of the segmented 3D point cloud, the segmented 3D point cloud corresponding to the 3D model, where the set of associations may be based on respective sets of parameters associated with each virtual camera of a set of multiple virtual cameras, and where the segmented 3D model may be based on associations between the respective points of the segmented 3D point cloud and respective meshes of the 3D model.

In some examples of the method, apparatus, and non-transitory computer-readable medium described herein, the associations between the respective points of the segmented 3D point cloud and the respective meshes of the 3D model may be determined in accordance with one or more threshold distances between the respective points and the respective meshes, in accordance with one or more voxelization procedures on the respective points and intersection-over-union information for the respective meshes, in accordance with color information for the respective points and the respective meshes, or any combination thereof.

In some examples of the method, apparatus, and non-transitory computer-readable medium described herein, obtaining the set of multiple 2D images may include operations, features, means, or instructions for capturing the set of multiple 2D images using a set of multiple virtual cameras and based on respective sets of parameters associated with each virtual camera of the set of multiple virtual cameras.

In some examples of the method, apparatus, and non-transitory computer-readable medium described herein, performing the backprojection operations may include operations, features, means, or instructions for performing the backprojection operations using raycasting for the respective pixels in each image segmentation mask, where the correspondence may be based on an intersection between a respective object of the 3D model and a ray associated with a pixel in accordance with the raycasting, the method further including and identifying a set of multiple segments of the segmented 3D model based on the raycasting and one or more image masks that may be each associated with a respective image segmentation mask of the set of multiple image segmentation masks.

Some examples of the method, apparatus, and non-transitory computer-readable medium described herein may further include operations, features, means, or instructions for assigning a label from each object of an image segmentation mask to a corresponding object of the 3D model based on the correspondence.

Some examples of the method, apparatus, and non-transitory computer-readable medium described herein may further include operations, features, means, or instructions for resolving, for each object of the 3D model, one or more conflicts between respective labels of the one or more labels after merging the sets of the one or more labels, where the resolving may be based on one or more votes for the respective labels.

In some examples of the method, apparatus, and non-transitory computer-readable medium described herein, a first server may be associated with the generating the set of multiple 2D images, a second server may be associated with the generating the set of multiple image segmentation masks, a third server may be associated with the performing the backprojection operations, a fourth server may be associated with the merging the sets of the one or more labels, and a fifth server may be associated with the generating the segmented 3D model, or any combination thereof, may be associated with one or more servers.

Some examples of the method, apparatus, and non-transitory computer-readable medium described herein may further include operations, features, means, or instructions for performing the one or more segmentation operations on each two-dimensional image, where the respective objects of the set of multiple image segmentation masks may be identified based on one or more object detection models, and where a respective image segmentation mask of the set of multiple image segmentation masks may be based on identifying the respective objects.

In some examples of the method, apparatus, and non-transitory computer-readable medium described herein, the one or more segmentation operations include instance segmentation based on respective instance information associated with each 2D image that may be applied to the segmented 3D model.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for segmenting models in accordance with one or more aspects of the present disclosure.

FIG. 2 shows an example of a computer vision pipeline that supports techniques for segmenting models in accordance with one or more aspects of the present disclosure.

FIG. 3 shows an example of a 3D segmentation process that supports techniques for segmenting models in accordance with one or more aspects of the present disclosure.

FIG. 4 shows an example of a process flow that supports techniques for segmenting models in accordance with one or more aspects of the present disclosure.

FIG. 5 shows an example of a flowchart that supports techniques for segmenting models in accordance with one or more aspects of the present disclosure.

FIGS. 6 and 7 show block diagrams of devices that support techniques for segmenting models in accordance with one or more aspects of the present disclosure.

FIG. 8 shows a block diagram of a data management component that supports techniques for segmenting models in accordance with one or more aspects of the present disclosure.

FIG. 9 shows a diagram of a system including a device that supports techniques for segmenting models in accordance with one or more aspects of the present disclosure.

FIG. 10 shows a diagram of a system including a UE that supports techniques for segmenting models in accordance with one or more aspects of the present disclosure.

FIG. 11 shows a diagram of a system including a network entity that supports techniques for segmenting models in accordance with one or more aspects of the present disclosure.

FIG. 12 shows a flowchart illustrating methods that support techniques for segmenting models in accordance with one or more aspects of the present disclosure.

### DETAILED DESCRIPTION

Various devices may be capable of utilizing visual data to identify and understand objects included within images and video. Such techniques may be referred to as computer vision, which may implement one or more artificial intelligence (AI) and/or machine learning (ML) models and/or functionalities (which may include deep learning and other models/functionalities). Computer vision may refer to techniques including one or more computing devices that replicate the way in which humans see and determine what is being viewed. Computer vision may be based on one or multiple devices (e.g., sensing devices) that are capable of capturing video and/or digital images and used (e.g., by one or more servers, which may correspond to cloud computing) as an input to one or more AI/ML models/functionalities for identifying information within the visual data. As an example, information about one or more physical objects in a three-dimensional (3D) scene, which may be a digital representation of the geometry of the one or more physical objects and orientation in 3D space, may be obtained by sensing devices in accordance with one or more techniques. Various algorithms may be used to process the visual data, where such algorithms may be trained on some quantity of information to enable the algorithms to identify patterns in the visual data and identify corresponding content (e.g., objects, structures, individuals).

In some cases, image segmentation techniques may be utilized for computer vision, which may include classifying and labeling information (e.g., pixels) within an image. Some foundation models, such as a segment-anything model (SAM), may perform query-based segmentation on images. Using such models, masks may be automatically generated to segment all of the objects included in an image, where a mask may be a two-dimensional (2D) matrix having binary entries (e.g., a binary 2D matrix) having a same spatial dimension as an input image, and each element (e.g., M (i, j)) of the matrix may indicate a presence (e.g., 1) or absence (e.g., 0) of a specific object or region at some pixel location (e.g., i, j).

3D scenes associated with computer vision may be represented in various formats, including point cloud formats and mesh/surface formats. A 3D point cloud may be a 3D data representation of the world captured via one or more sensing devices, which may include a collection of individual points defined by x, y, and z coordinates. 3D meshes may be models comprising vertices, edges, and faces that correspond to polygons (e.g., triangles, quadrilaterals) representing 3D objects, and such techniques may be relatively more prevalent in the gaming, film, and design industries. Point clouds may be associated with relatively increased accuracy and detailed representations of scenes but may also be associated with relatively slow rendering operations and/or increased processing requirements. Meshes/surfaces may be associated with relatively faster rendering operations, improved manipulation of visual data, and improved aesthetic representation.

3D segmentation may generally include labeling various regions of data representing a 3D scene or environment. Segmentation of a 3D model (e.g., a digital surface model, a 3D mesh) may be important in various applications and technologies, such as digital twin technologies, extended reality (XR) technologies (e.g., including virtual reality (VR), augmented reality (AR), mixed reality (MR)), gaming, or the like. Additionally, digital twin technologies may include generating up-to-date representations of a real physical object, where a digital twin may further enable simulation and testing of how such objects may perform. As such, digital twin technologies may be used in various industries, including aerospace, automotive, manufacturing, logistics, and medicine. In some examples, a digital twin (e.g., a radio frequency (RF) digital twin) may be generated by mapping RF properties onto a 3D scene, where wireless performance of a corresponding wireless communications system may be simulated using the RF digital twin. Such digital twins may therefore be used to analyze and improve (e.g., optimize) the performance of one or more wireless communications systems, and corresponding simulations may capture phenomena that may affect one or more wireless channels, where such phenomena may include reflection, absorption, scattering by various object of different material types in the scene, among other examples. In any case, 3D model segmentation may enable the segmentation of different components within a 3D scene, allowing for distinct computational processing for each component.

Some techniques for 3D mesh segmentation, such as frameworks that predict masks in point clouds, may be implemented for 3D point clouds that are segmented. The segmentation of such point clouds may be achieved by clustering points of the 3D point cloud into distinct semantic parts that represent surfaces, objects, and/or structures in an environment. The mesh may then be reconstructed from the point cloud after segmentation. However, reconstruction of the mesh from the point cloud may introduce losses and, as a result, real-life results may not match predictions using the corresponding digital twin. Further, the application of point cloud 3D semantic segmentation techniques to a 3D mesh model may require that the 3D mesh model first be converted to a point cloud. But wireless raytracing techniques may, in some cases, require surfaces/meshes associated with the 3D mesh model to simulate reflection and/or refraction and other interactions associated with wireless communications by various wireless communication devices (such as user equipment (UEs) and/or network entities, among other examples). In such cases, the conversion of point clouds back to mesh format (e.g., using techniques such as Poisson reconstruction) may result in inaccurate surface representations. That is, converting a 3D mesh model to a point cloud for semantic segmentation, and then converting the point cloud back to the 3D mesh may result in inaccuracies that affect the quality and accuracy of a digital twin, thereby preventing accurate and robust simulations, such as for mapping RF properties for an environment/scene and other applications.

In some cases, as described herein, techniques may be used to segment respective object types included in a 3D model, which may avoid lossy reconstruction of a 3D mesh from a point cloud. For example, a computer vision pipeline or algorithm may be implemented by one or more devices to obtain a 3D model of a scene (e.g., a collection of polygons in a 3D space), perform 3D semantic segmentation, perform backprojection, merge respective labels based on the segmentation, and generate a labeled segmented model based on the merged labels. In some aspects, the 3D model obtained as an input may include colors and textures and may be associated with a coordinate frame (e.g., a known coordinate frame). In some aspects, the 3D model may be an unsegmented 3D mesh that may include one or more views (such as a 3D mesh color view, a 3D mesh skeleton view, and/or a 3D mesh surface view, among other examples).

Additionally, or alternatively, segmentation of a 3D mesh may be performed based on associations between points in a reconstructed 3D model (e.g., after segmentation) with meshes of an original 3D model. The described techniques may be used instead of conversion from a mesh format to a point cloud for the purpose of semantic segmentation, and then converting back to the mesh format, which may achieve improved accuracy in surface representation for the final segmented 3D model. As an example, a mesh model may be converted to a point cloud, and one or more point cloud semantic segmentation techniques may be applied to segment the point cloud. Then, an association may be formed between each point in the reconstructed 3D model with a mesh in the original 3D model. The association may be based on, for example, a nearest corresponding mesh surface to the point, voxelization of each point, followed by the mesh with a relatively highest intersection over union (IoU) (e.g., a metric that measures how well a bounding box may match a location of an object), color and/or depth information (such as red, green, blue (RGB) information), or any combination thereof. In such cases, because the point cloud to mesh association is performed on the original mesh, the described techniques may prevent accuracy loss due to mesh reconstruction. Additionally, such techniques may enable improved accuracy for ray tracing.

Particular aspects of the subject matter described in this disclosure may be implemented to realize one or more of the following potential advantages. For example, in accordance with aspects of the present disclosure, the computer vision pipeline may be based on one or more pre-trained 2D image segmentation models, and the pipeline may accordingly avoid the need for additional or customized training for 3D segmentation operations. Such features may make the computer vision pipeline both scalable and applicable to various use cases and applications (e.g., the computer vision pipeline may be a general-purpose pipeline capable of handling various types of 3D segmentation tasks). Further, the techniques described herein may enable relatively high-quality dense segments for 3D models of arbitrary shapes and sizes. Further, the described computer vision pipeline may be an example of an open-vocabulary pipeline, and the pipeline may accordingly segment any 3D object size or type in a 3D scene. In some aspects, the described techniques may enable robust mechanisms for labeling 3D meshes by merging outputs from multiple captures to obtain a final label for respective meshes. The merging algorithms described herein may also handle cases where some polygons of a mesh are unlabeled or incorrectly labeled, thereby enabling comprehensive labeling techniques for meshes. The described techniques may be used, for example, by map vendors, gaming companies, animation studios, AR/VR/XR companies, among other examples.

As used herein, a 3D model can include a digital representation of a 3D scene or object including meshes/surfaces (e.g., polygons with vertices, edges, and faces), point clouds (e.g., x, y, z points, optionally with color or depth), voxels, neural radiance fields, or other 3D formats, and may include information such as colors, textures, materials, coordinates, and camera/scene parameters. A 3D model can also include a digital twin that maps physical properties and behaviors onto 3D representations for simulation and analysis. Further, a scene or 3D scene represented by a 3D model can include a spatially bounded environment including one or more 3D objects and their relationships within a coordinate frame, such as a geographic area (e.g., streets, buildings, vegetation) or object-centric setting, and may be represented by any 3D model format (e.g., meshes, point clouds, voxels, neural radiance fields, or a digital twin) with associated colors, textures, materials, and camera/scene parameters such as contextual metadata such as time, location, and type.

Aspects of the disclosure are initially described in the context of wireless communications systems. One or more aspects of the described techniques may be described with reference to a computer vision pipeline, a corresponding 3D segmentation process, object modification timelines, as well as process flows and flowcharts. Aspects of the disclosure are further illustrated by and described with reference to apparatus diagrams, system diagrams, and flowcharts that relate to techniques for segmenting models (e.g., segmenting mesh models).

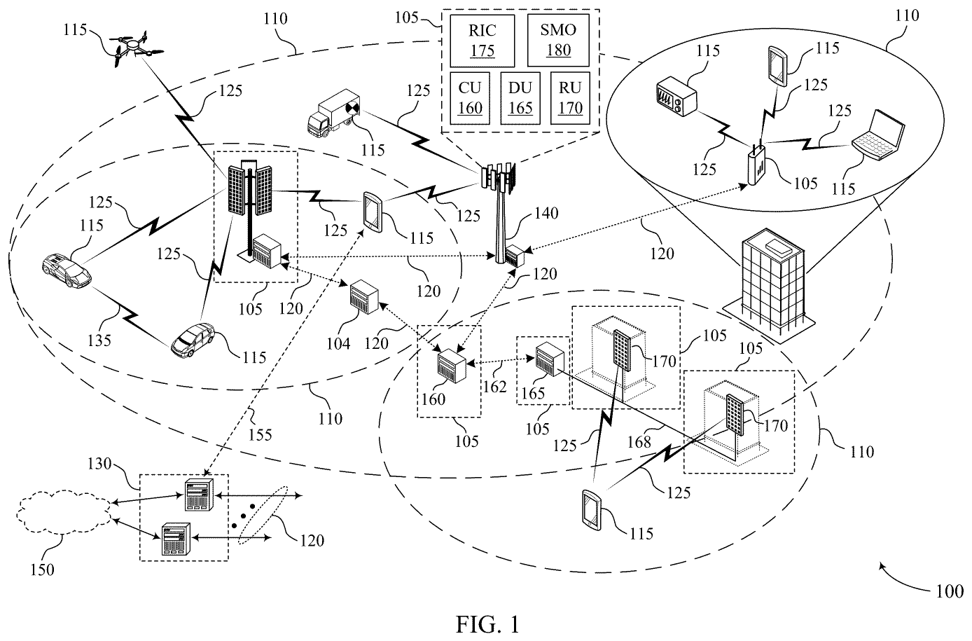

FIG. 1 shows an example of a wireless communications system 100 that supports techniques for segmenting models in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long-Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for segmenting models as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The network entity 105 and the UE 115 may communicate one or more packets of data associated with various applications, such as extended reality (XR) applications. XR may generally refer to one or more immersive technologies including, for example, augmented reality (AR), virtual reality (VR), and mixed reality (MR). XR communications may have various traffic characteristics. For example, the UE 115 transmit various packet sizes and quantity of packets per transmission burst for XR applications. Further, the UE 115 may transmit, or receive, the burst of packets for XR applications in accordance with non-integer periods, where such non-integer periods may be based on the XR application. As an illustrative example, an XR application may operate at 1/60 frames per second (FPS), as such the UE may transmit, or receive, the burst of packets in accordance with a period of 16.67 milliseconds (ms) (e.g., 1/60 FPS=16.67 ms). As another illustrative example, the XR application may operate at 1/120 FPS, as such, the UE may transmit, or receive, the burst of packets in accordance with a period of 8.33 ms (e.g., 1/120 FPS=8.33 ms).

In some examples, a UE 115 may support AI and/or ML models and/or functionalities, which the UE 115 may use to perform various wireless communications procedures (e.g., CSI prediction, beam selection, and/or beam prediction, among other examples). In such cases, the UE 115 may generate inference data using one or more AI/ML models/functionalities. Additionally, or alternatively, the UE 115 may perform life cycle management (LCM) operations for a given AI/ML model and/or functionality (e.g., model or functionality selection, activation, deactivation, switching, and fallback, among other examples) based on one or more AI/ML models/functionalities. In some aspects, LCM may be model-based or functionality-based LCM procedures. As described herein, an AI functionality or AI model may be referred to as an ML functionality or ML model, or vice versa. That is, the terms “AI” and “ML” may, in some examples, be used interchangeably to refer to similar technologies, models, functions, algorithms, or any combination thereof. Similarly, the terms “model” and “functionality” may be used interchangeably. In some examples, ML operations may be considered a subset of AI operations. In any case, aspects of the features described herein may be referred to as AI functionalities, AI functions, AI models, AI services, AI operations, or the like, and such features may be similarly applicable to ML functionalities, ML functions, ML models, ML services, ML operations, or any combination thereof. Thus, reference to “ML” or “AI” may refer to ML, AI, or both, and the terms “AI” or “ML” should not be considered limiting to the scope of the claims or the disclosure.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

The wireless communications system 100 may include, and enable the communication between, one or more computing devices. For example, the wireless communications system 100 may include one or more of an AI-integrated computing system, a data management system (DMS), and one or more computing devices, which may be in communication with one another via a network. In some examples, the AI-integrated computing system, and the DMS may communicate (e.g., exchange information) with one another. The network may include aspects of one or more wired networks (e.g., the Internet), one or more wireless networks (e.g., cellular networks), or any combination thereof. The network may include aspects of one or more public networks or private networks, as well as secured or unsecured networks, or any combination thereof. The network also may include any quantity of communications links and any quantity of hubs, bridges, routers, switches, ports or other physical or logical network components.

A computing device may be used to input information to or receive information from the AI-integrated computing system, the DMS, or both. For example, a user of the computing device may provide user inputs via the computing device, which may result in commands, data, or any combination thereof being communicated via the network to the AI-integrated computing system, the DMS, or both. Additionally, or alternatively, a computing device may output (e.g., display) data or other information received from the AI-integrated computing system, the DMS, or both. A user of a computing device may, for example, use the computing device to interact with one or more user interfaces (e.g., graphical user interfaces (GUIs)) to operate or otherwise interact with the AI-integrated computing system, the DMS, or both. It is to be understood that any quantity of computing devices may be utilized to perform aspects of the techniques described herein.

A computing device may be a stationary device (e.g., a desktop computer or access point) or a mobile device (e.g., a laptop computer, tablet computer, or cellular phone). In some examples, a computing device may be a commercial computing device, such as a server or collection of servers. And in some examples, a computing device may be a virtual device (e.g., a virtual machine). In some cases, a computing device may be included in (e.g., may be a component of) the AI-integrated computing system and/or the DMS.

The AI-integrated computing system may include one or more servers and may provide (e.g., to the one or more computing devices) local or remote access to applications, databases, or files stored within the AI-integrated computing system. The AI-integrated computing system may further include one or more data storage devices. In some cases, the AI-integrated computing system may include any quantity of servers and any quantity of data storage devices, which may be in communication with one another and collectively perform one or more functions ascribed herein to the server and data storage device. In some examples, the AI-integrated computing system may support deep learning (e.g., machine learning using artificial neural networks to learn from data) and other AI/ML models and functionalities.

A data storage device may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device may be a database (e.g., a relational database), and a server may host (e.g., provide a database management system for) the database.

A server may allow a client (e.g., a computing device) to download information or files (e.g., executable, text, application, audio, image, or video files) from the AI-integrated computing system, to upload such information or files to the AI-integrated computing system, or to perform a search query related to particular information stored by the AI-integrated computing system. In some examples, a server may act as an application server or a file server. In general, a server may refer to one or more hardware devices that act as the host in a client-server relationship or a software process that shares a resource with or performs work for one or more clients.

A server may include a network interface, processor, memory, disk, and computing system manager. The network interface may enable the server to connect to and exchange information via the network (e.g., using one or more network protocols). The network interface may include one or more wireless network interfaces, one or more wired network interfaces, or any combination thereof. The processor may execute computer-readable instructions stored in the memory in order to cause the server to perform functions ascribed herein to the server. The processor may include one or more processing units, such as one or more central processing units (CPUs), one or more graphics processing units (GPUs), or any combination thereof. The memory may comprise one or more types of memory (e.g., random access memory (RAM), static random-access memory (SRAM), dynamic random-access memory (DRAM), read-only memory (ROM), electrically erasable programmable read-only memory (EEPROM), Flash, etc.). Disk may include one or more HDDs, one or more SSDs, or any combination thereof. Memory and disk may comprise hardware storage devices. The computing system manager may manage the AI-integrated computing system or aspects thereof (e.g., based on instructions stored in the memory and executed by the processor) to perform functions ascribed herein to the AI-integrated computing system. In some examples, the network interface, processor, memory, and disk may be included in a hardware layer of a server, and the computing system manager may be included in a software layer of the server. In some cases, the computing system manager may be distributed across (e.g., implemented by) multiple servers within the AI-integrated computing system.

In some examples, the AI-integrated computing system or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the AI-integrated computing system or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices over the network). IaaS may refer to a service in which physical computing resources are used to instantiate one or more virtual machines, the resources of which are made available to one or more client devices over a network (e.g., to one or more computing devices over the network).

In some examples, the AI-integrated computing system or aspects thereof may implement or be implemented by one or more virtual machines. The one or more virtual machines may run various applications, such as a database server, an application server, or a web server. For example, a server may be used to host (e.g., create, manage) one or more virtual machines, and the computing system manager may manage a virtualized infrastructure within the AI-integrated computing system and perform management operations associated with the virtualized infrastructure. The computing system manager may manage the provisioning of virtual machines running within the virtualized infrastructure and provide an interface to a computing device interacting with the virtualized infrastructure. For example, the computing system manager may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk, the memory, the processor, the network interface, the data storage device, or any combination thereof in support of running the various applications. Storage resources (e.g., the disk, the memory, or the data storage device) that are virtualized may be accessed by applications as a virtual disk.

The DMS may provide one or more data management services for data associated with the AI-integrated computing system and may include DMS manager and any quantity of storage nodes. The DMS manager may manage operation of the DMS, including the storage nodes. Though illustrated as a separate entity within the DMS, the DMS manager may in some cases be implemented (e.g., as a software application) by one or more of the storage nodes. In some examples, the storage nodes may be included in a hardware layer of the DMS, and the DMS manager may be included in a software layer of the DMS. The DMS may be separate from the AI-integrated computing system but in communication with the AI-integrated computing system via a network. It is to be understood, however, that in some examples at least some aspects of the DMS may be located within AI-integrated computing system. For example, one or more servers, one or more data storage devices, and at least some aspects of the DMS may be implemented within the same cloud environment or within the same data center.

Storage nodes of the DMS may include respective network interfaces, processors, memories, and disks. The network interfaces may enable the storage nodes to connect to one another, to the network, or both. A network interface may include one or more wireless network interfaces, one or more wired network interfaces, or any combination thereof. The processor of a storage node may execute computer-readable instructions stored in the memory of the storage node in order to cause the storage node to perform processes described herein as performed by the storage node. A processor may include one or more processing units, such as one or more CPUs, one or more GPUs, or any combination thereof. The memory may comprise one or more types of memory (e.g., RAM, SRAM, DRAM, ROM, EEPROM, Flash, etc.). A disk may include one or more HDDs, one or more SDDs, or any combination thereof. Memories and disks may comprise hardware storage devices. Collectively, the storage nodes may in some cases be referred to as a storage cluster or as a cluster of storage nodes.

In some examples, the DMS may provide a data classification service, a malware detection service, a data transfer or replication service, backup verification service, or any combination thereof, among other possible data management services for data associated with the AI-integrated computing system. For example, the DMS may analyze data included in one or more computing objects of the AI-integrated computing system, metadata for one or more computing objects of the AI-integrated computing system, or any combination thereof, and based on such analysis, the DMS may identify locations within the AI-integrated computing system that include data of one or more target data types (e.g., sensitive data, such as data subject to privacy regulations or otherwise of particular interest) and output related information (e.g., for display to a user via a computing device).

In some examples, the DMS, and in particular the DMS manager, may be referred to as a control plane. The control plane may manage tasks, such as storing data management data or performing restorations, among other possible examples. The control plane may be common to multiple customers or tenants of the DMS. For example, the AI-integrated computing system may be associated with a first customer or tenant of the DMS, and the DMS may similarly provide data management services for one or more other computing systems associated with one or more additional customers or tenants. In some examples, the control plane may be configured to manage the transfer of data management data to a cloud environment (e.g., Microsoft Azure or Amazon Web Services). In addition, or as an alternative, to being configured to manage the transfer of data management data to the cloud environment, the control plane may be configured to transfer metadata for the data management data to the cloud environment. The metadata may be configured to facilitate storage of the stored data management data, the management of the stored management data, the processing of the stored management data, the restoration of the stored data management data, and the like.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support one or more computer vision pipelines that are implemented (e.g., by one or multiple devices, such as computing devices) to enable accurate and detailed segmentation of various 3D models (e.g., of any 3D model). For example, multiple 2D images may be generated from a 3D mesh, and multiple image segmentation masks may be generated based on segmentation operations performed on each 2D image. Backprojection operations may be performed for each image segmentation mask, where a correspondence between respective pixels of each image segmentation mask and respective objects of the 3D mesh is identified in accordance with the backprojection operations. Further, sets of labels from each image segmentation mask may be merged based on the correspondence, and the respective objects may be associated with a label in accordance with the merging. A segmented 3D mesh may be generated that corresponds to the original 3D mesh, where the segmented 3D mesh includes the respective objects having an associated label. In some aspects, the described techniques may be used to generate a digital twin, for example, to simulate various aspects of wireless communications within the wireless communications system 100, which may enable various enhancement and improvements to the associated communications.

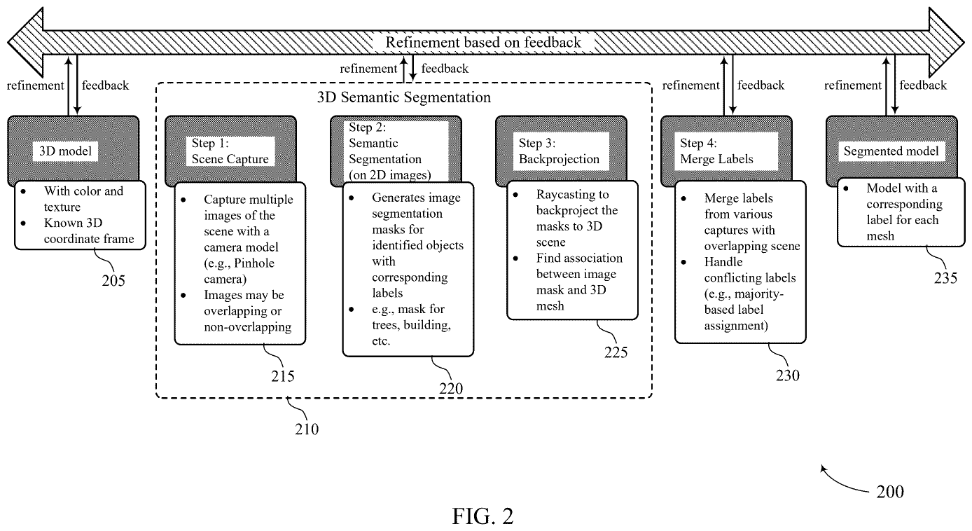

FIG. 2 shows an example of a computer vision pipeline 200 that supports techniques for segmenting models in accordance with one or more aspects of the present disclosure. The computer vision pipeline 200 may implement, or be implemented by, one or more aspects of the wireless communications system 100. In some aspects, the computer vision pipeline 200 may support techniques for the generation of labeled and segmented 3D models with increased accuracy.

Various devices may be capable of utilizing visual data to identify and understand objects included within images and video. Such techniques may be referred to as computer vision, which may implement one or more AI and/or ML models and/or functionalities (which may include deep learning and other models/functionalities). Computer vision may refer to techniques by which one or more computing devices replicate the way in which humans see and determine what is being viewed. Computer vision may be based on one or multiple devices (e.g., sensing devices) that are capable of capturing video and/or digital images and used (e.g., by one or more servers, which may correspond to cloud computing) as an input to one or more AI/ML models/functionalities for identifying information within the visual data. As an example, information about one or more physical objects in a 3D scene, which may be a digital representation of the geometry of the one or more physical objects and orientation in 3D space, may be obtained by sensing devices in accordance with one or more techniques. Such techniques may include photogrammetry (e.g., utilizing multiple overlapping images from different angles), imaging via stereo cameras (e.g., using cameras having two or more lenses with separate image sensors), light detection and ranging (LiDAR) and other remote sensing technologies, laser scanning (e.g., for measuring distances to various points on an object and creating a point cloud), structured light technologies (e.g., projecting a pattern of light and using distortion to determine shapes), computed tomography (e.g., using x-rays to obtain images of internal structures), among other examples. Various algorithms may be used to process the visual data, where such algorithms may be trained on some quantity of information to enable the algorithms to identify patterns in the visual data and identify corresponding content (e.g., objects, structures, individuals).

In some cases, image segmentation techniques (e.g., zero-shot segmentation) may be utilized for computer vision based on scalability and adaptability associated with such techniques. Image segmentation may include classifying and labeling information (e.g., pixels) within an image. Some foundation models (e.g., large-scale neural network architectures pre-trained on large datasets), such as a SAM, may perform query-based segmentation on images. Using such models, masks may be automatically generated to segment all of the objects included in an image, where a mask may be a 2D matrix having binary entries (e.g., a binary 2D matrix) having a same spatial dimension as an input image, and each element (e.g., M(i,j)) of the matrix may indicate a presence (e.g., 1) or absence (e.g., 0) of a specific object or region at some pixel location (e.g., i, j).

3D scenes may be represented in various formats, including point cloud formats and mesh/surface formats. A 3D point cloud may be a 3D data representation of the world captured via one or more sensing devices, which may include a collection of individual points defined by x, y, and z coordinates. 3D meshes may be models comprising vertices, edges, and faces that correspond to polygons (e.g., triangles, quadrilaterals) representing 3D objects, and such techniques may be relatively more prevalent in the gaming, film, and design industries. Point clouds may be associated with relatively increased accuracy and detailed representations of scenes but may also be associated with relatively slow rendering operations and/or increased processing requirements. Meshes/surfaces may be associated with relatively faster rendering operations, improved manipulation of visual data, and improved aesthetic representation.

In some cases, however, there may not be any well-established foundation models for direct 3D mesh segmentation. 3D segmentation may generally include labeling of various regions of data representing a 3D scene or environment. As an example, an input for 3D segmentation may include a 3D model showing one or more structures through respective surfaces of such structures, a 3D model showing the one or more structures including the respective surfaces and color, or both. In some cases, inputs for 3D image segmentation may include unsegmented 3D models having, for example, N 3D surfaces (which may be called meshes, faces, polygons, or other similar terminology) and color. An output of the 3D segmentation may include a 3D segmented model, such as a 3D model showing structures via multiple segments, which may have some quantity of segments (e.g., the quantity of segments, K, may be less than a quantity of 3D surfaces (e.g., K<<N)), the N 3D surfaces (retained from the input), the color (retained from the input), and a respective label for each mesh. Segmentation of a 3D mesh (e.g., a digital surface model) may be important in various applications and technologies, such as digital twin technologies, extended reality (XR) technologies (e.g., including virtual reality (VR), augmented reality (AR), mixed reality (MR), gaming, or the like). In some cases, digital twin technologies may include generating up-to-date representations of a real physical object, where a digital twin may further enable simulation and testing of how such objects may perform. As such, digital twin technologies may be used in various fields, including aerospace, automotive, manufacturing, logistics, and medicine. In any case, 3D mesh segmentation may enable the segmentation of different components within a 3D scene, allowing for distinct computational processing for each component.

In some examples, a digital twin (e.g., a radio frequency (RF) digital twin) may be generated by mapping RF properties onto a 3D scene, where wireless performance of a corresponding wireless communications system may be simulated using the RF digital twin. Such digital twins may therefore be used to analyze and improve (e.g., optimize) the performance of one or more wireless communications systems. For example, ray tracing may be used to simulate wireless signal reception at one or more locations within the 3D scene, where the wireless signals may be simulated as being transmitted from a respective transmitter (e.g., a transmitting wireless communication device, such as one or more network entities 105 or UEs 115). Such simulations may capture phenomena that may affect one or more wireless channels, where such phenomena may include reflection, absorption, scattering by various object of different material types in the scene, among other examples. Simulations achieved by generating the RF digital twin for different wireless communications systems may accordingly facilitate near-real-life wireless simulation and performance evaluations.

Some techniques for 3D mesh segmentation, such as frameworks that predict masks in point clouds (such as SAM3D), may be implemented for 3D point clouds that are segmented. The segmentation of such point clouds may be achieved by clustering points of the 3D point cloud into distinct semantic parts that represent surfaces, objects, and/or structures in an environment. The mesh may then be reconstructed from the point cloud after segmentation. However, reconstruction of the mesh from the point cloud may introduce losses and, as a result, real-life results may not match predictions using the corresponding digital twin.

As described herein, techniques may be used to segment respective object types included in a 3D mesh (e.g., a collection of polygons in a 3D space), which may avoid lossy reconstruction of the mesh from a point cloud. For example, a computer vision pipeline or algorithm may be implemented by one or more devices to obtain a 3D model of a scene 205, perform 3D semantic segmentation (210), perform backprojection (225), merge respective labels based on the segmentation (230), and generate a labeled segmented model based on the merged labels (235). In some aspects, the 3D model obtained as an input may include colors and textures and may be associated with a coordinate frame (e.g., a known coordinate frame). In some aspects, the 3D model may be an unsegmented 3D mesh that may include one or more views (such as a 3D mesh color view, a 3D mesh skeleton view, and/or a 3D mesh surface view, among other examples).

Particular aspects of the subject matter described in this disclosure may be implemented to realize one or more of the following potential advantages. For example, in accordance with one or more aspects of the present disclosure, the computer vision pipeline may be based on one or more pre-trained 2D image segmentation models, and the pipeline may accordingly avoid the need for additional or customized training for 3D segmentation operations. Such features may make the computer vision pipeline both scalable and applicable to various use cases and applications (e.g., the computer vision pipeline may be a general-purpose pipeline capable of handling various types of 3D segmentation tasks). Further, the techniques described herein may enable relatively high-quality dense segments for 3D models of arbitrary shapes and sizes. Further, the described computer vision pipeline may be an example of an open-vocabulary pipeline, and the pipeline may accordingly segment any 3D object size or type in a 3D scene. In some aspects, the described techniques may enable robust mechanisms for labeling 3D meshes by merging outputs from multiple captures to obtain a final label for respective meshes. The merging algorithms described herein may also handle cases where some of polygons of a mesh are unlabeled or incorrectly labeled, thereby enabling comprehensive labeling techniques for meshes. The described techniques may be used, for example, by map vendors, gaming companies, animation studios, AR/VR/XR companies, among other examples.

The 3D semantic segmentation techniques (210) described herein may include scene capture (215), semantic segmentation (220), and backprojection techniques (225). For example, the scene capture techniques may include capturing multiple images (e.g., multiple unsegmented 2D images) of a scene associated with the 3D model (215). In some examples, the respective images may be captured using one or more camera models, such as a pinhole camera model or other models, and the images may be overlapping or non-overlapping. The computer vision pipeline 200 may then perform segmentation (e.g., semantic segmentation) for the multiple images (e.g., on the 2D images) (220). Here, semantic segmentation may be performed for each unsegmented 2D image of the multiple 2D images. In some aspects, the segmentation performed on the images may generate a set of image segmentation masks for one or more identified objects having corresponding labels (e.g., window, façade, tree, fountain, bench, or the like). For instance, the set of image segmentation masks may include a mask for trees, a mask for buildings, or the like, for a particular scene. For the backprojection operations (225), one or more raycasting procedures may be performed to backproject the masks to the 3D scene. Raycasting may refer to the use of virtual rays (e.g., virtual light rays) with 3D images, where the rays may intersect with one or more objects in a 3D scene, and some information may be determined based on these intersections. In such cases, associations between an image mask and a 3D mesh may be identified. That is, a correspondence between respective pixels in each image segmentation mask of the set of image segmentation masks may enable such segmentation to be transferred from a 2D image to the 3D model (215) (e.g., the original 3D model). In some examples, the correspondence between the pixels and the 3D model (215) may be identified based on the backprojection operations (225).

Following the 3D semantic segmentation, labels may be merged (230). For instance, respective labels from various captures associated with an overlapping scene may be merged. In some aspects, one or more conflicting labels may be handled by the algorithm, for example, using majority-based label assignment (e.g., where a data point may be assigned a label based on a “majority vote” of predicted labels from multiple sources). In any case, the backprojection and merging may result in a labeled and segmented 3D mesh including the various labels (e.g., window, façade, foliage, bench, sidewalk, tree, among other examples). As such, the segmented model may be generated after the labels are merged (235), and the segmented model may be a model with a corresponding label for each mesh. In some aspects, one or more feedback and/or refinement processes may be used with the techniques described herein. For example, refinement and/or feedback may be implemented to modify one or more portions of the computer vision pipeline, including, for example, for the input 3D model, for the 3D semantic segmentation, for merging labels, and for generating the segmented model.

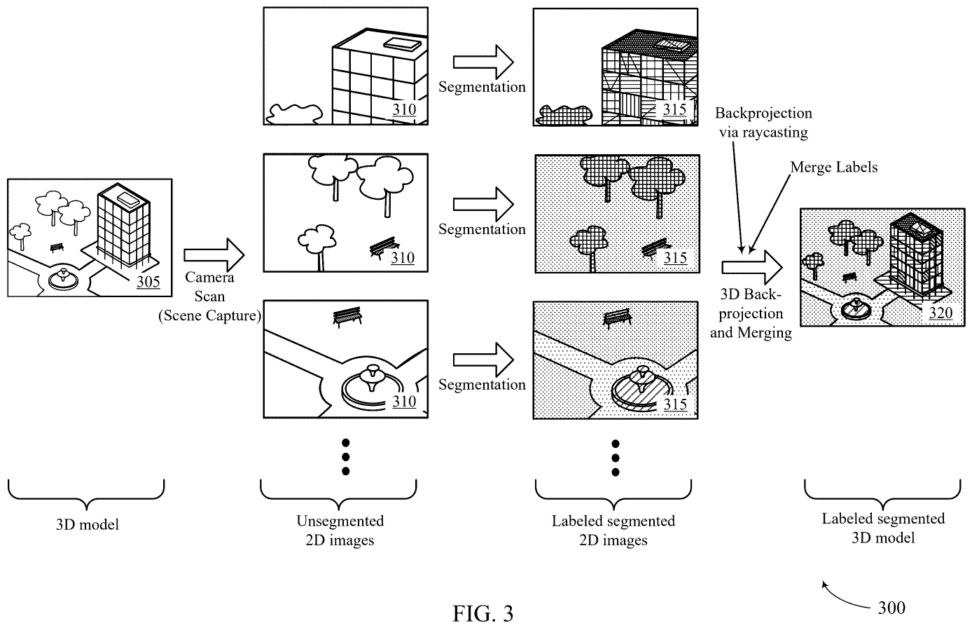

FIG. 3 shows an example of a 3D segmentation process 300 that supports techniques for segmenting models in accordance with one or more aspects of the present disclosure. The 3D segmentation process 300 may implement, or be implemented by, one or more aspects of the wireless communications system 100 and the computer vision pipeline. As an example, the 3D segmentation process 300 may be an example of data at various stages of the computer vision pipeline 200.

As described herein, a computer vision pipeline or algorithm may be implemented by one or more devices to obtain a 3D model 305 of a scene, perform 3D semantic segmentation, perform backprojection, merge respective labels based on the segmentation, and generate a labeled segmented model 320 based on the merged labels. In some aspects, the 3D model 305 obtained as an input may include colors and textures and may be associated with a coordinate frame (e.g., a known coordinate frame). In some aspects, the 3D model 305 may be an unsegmented 3D mesh that may include one or more views (such as a 3D mesh color view, a 3D mesh skeleton view, or a 3D mesh surface view, among other examples).

Various cameras may be configured to obtain the multiple images 310 (e.g., multiple 2D images, multiple unsegmented 2D images) of the 3D model 305. For example, multiple virtual cameras (e.g., simulated cameras) that may capture different views of the 3D scene (which may be referred to as a camera scan). As an example, multiple virtual cameras may be placed around the 3D model 305 to achieve comprehensive coverage. Camera models may be associated with intrinsic parameters (such as focal length (fx, fy) and principal point (cx, cy), which may be part of a camera matrix that describes how the camera transforms 3D coordinates into 2D coordinates on an image) and extrinsic parameters (such as pose, e.g., rotation, translation). These parameters may be a function of the camera location, for example, including the use of a wide-angle for whole view and zoom setting to focus on particular regions deemed important for a digital twin function. In some examples, a pinhole camera (e.g., a pinhole camera model) may be used.

Comprehensive coverage may be obtained by the multiple virtual cameras corresponding to multiple image captures with overlapping regions of the scene, where a quantity of the cameras may enable certain portions (e.g., every major portion) of the 3D scene to appear in at least one captured image. In some cases, overlapping fields of view may be used to achieve redundancy and robustness for the captured images. Further, the quantity of cameras may be a function of available compute power, including capabilities to process and resolve overlaps.

One or more techniques may be used for the image segmentation performed on images 310 as part of the computer vision pipeline or algorithm yielding labeled segmented images 315. For example, in accordance with a first technique for image segmentation, training (e.g., model training) may not be required. As an example, each captured image may be with its respective camera pose (e.g., intrinsic and extrinsic parameters of a respective camera). Here, a scalable semantic segmentation pipeline may be used, where an input may be an image (e.g., an RGB image) of the model and respective camera pose. The output of the scalable semantic segmentation pipeline may be per-pixel semantic labels (e.g., windows, buildings, vegetation, unlabeled) and a corresponding camera pose may be retained. In such cases, the image goes may be processed through an Object Proposal generator model (e.g., SAM-based) that generates proposals for all the objects in the image and their corresponding masks. Each segmented region (e.g., a cropped part of the image) may be processed, for example, through an Open Vocabulary Object Classifier model (e.g., models that learn visual concepts from natural language supervision, such as CLIP-based models), which may assign labels to the segmented region and their corresponding masks. The classifier model may have a configurable threshold that corresponds to a threshold confidence level (e.g., minimum confidence level) of the classifier for the masks, and the classifier model may assign multiple labels with different confidence levels to the same region. Further, labels from all the masks are combined to form a final, labeled segmentation map of the original input image. In some aspects, combining may be a function of the confidence level for overlapping masks. Here, the described image segmentation techniques may use multiple unsegmented 2D images 310 to generate multiple labeled segmented 2D images 315 as depicted in computer segmentation process 300.

Additionally, or alternatively, in accordance with a second technique for image segmentation, the semantic segmentation may be achieved by detecting all of the objects in the scene by one or more object detection models, such as a you only look once (YOLO) model (or other real-time object detection models), a DEtection TRansformer (DETR) model (or other models utilizing a transformer encoder-decoder architecture), a faster region-convolutional neural network (Faster R-CNN) model (or other two-stage object detection models), or a custom-trained model, among other examples. For each detected object, a segmentation model (e.g., SAM model) may be used to find a primary object in the object boundary (e.g., bounding box) identified using the one objects detected in the scene. In some examples, boundaries may be fed as queries to the SAM model to generate segmentation masks with labels. For example, object detection may be performed on multiple unsegmented 2D images 310 (e.g., from captures of a 3D model 305), which may result in multiple 2D images with bounding boxes associated with respective objects (e.g., windows, façade, trees, or the like), and segmentation may be performed to generate multiple labeled segmented 2D images 315). Such techniques may be used to create a mask for each of the objects including, for example, a window, a building façade, and trees included in the RF model or digital twin. Additionally, or alternatively, a dedicated trained model may be used for image segmentation. Here, a specialized instance segmentation model (such as a mask R-CNN model) may be trained to detect and segment specific classes of objects directly.

Backprojection between segmentations masks may include one or more raycasting techniques. That is, backprojection between segmented 2D images and a 3D mesh (e.g., between segmented 2D images and an original 3D model) may be achieved via raycasting. For example, for each pixel in a segmented image (e.g., an image segmentation mask), a ray may be cast from a center of the virtual camera corresponding to the segmented image through the pixel into 3D space. An intersection of the ray with the 3D mesh may be identified (e.g., an intersection between the ray and a triangle of the 3D mesh where the ray hits). Further, based on the intersection, the semantic label associated with that pixel may be transferred to the intersected portion of the 3D mesh (e.g., the triangle on the mesh). In some examples, a confidence level associated with the label may also be transferred.

Raycasting may refer to a process of projecting rays from a camera center (e.g., a center of a virtual camera) through the 2D image plane, and into a 3D scene until the ray hits (e.g., is incident upon) a surface. In the example of a pinhole camera (e.g., in accordance with a pinhole camera model), each ray may be represented in accordance with the equation: R (t)=0+t\hat{D} for t≥0, where O is the camera center and \hat{D} is a normalized direction. Here, for each pixel in a 2D image, a unique \hat{D} may be used, and thus a unique ray may be determined. In some examples, the aforementioned ray equation may be used to find an intersection with one or more objects in the 3D scene (e.g., of the 3D mesh). One or more algorithms (such as bounding volume hierarchy (BVH), octree, algorithms associated with tree data structures for sets of geometric objects) may be utilized to efficiently identify ray-object intersections. In any case, raycasting techniques may be used to identify a correspondence between a pixel in a 2D image (e.g., a segmented 2D image) and a 3D triangle in the 3D mesh.

Raycasting and image masking may be used to segment a 3D model. As an example, the rays (e.g., all the rays) passing from a camera center through the 2D image may be identified (e.g., calculated), which may be performed for all of the pixels in the 2D image (and for all 2D images captured from the 3D model). Then, using the masks (e.g., one or more image segmentation masks) generated via the one or more segmentation operations, the identified rays may be masked (e.g., use the masks generated at Step 2 of the pipeline to mask the rays). In some aspects, only the rays passing through the image segmentation mask may be allowed to pass through the image plane and hit (e.g., be incident upon) a surface of the 3D model. A first point of intersection with the 3D model may be found, and a corresponding mesh may be identified. As a result, a correspondence of the 3D mesh to the pixels in an image may be identified. In such cases, a same label may be assigned to the triangle mesh as the segmentation mask. That is, a label corresponding to the image segmentation mask may be assigned to the triangle of the 3D mesh based on a correspondence identified by the intersection of the ray (e.g., corresponding to a pixel of the image segmentation mask) and the 3D mesh.

As an illustrative example, all rays from the camera center may be incident upon the 3D model, and using a segmentation mask in the image plane, the rays may be masked through the image plane, which may correspond to a portion of the 3D model at which the (masked) rays are incident. This may accordingly be the correspondence between the portion of the mesh that is hit by the rays from the camera and the pixel associated with the camera.

In some aspects, conflict resolution and merging procedures may be performed. For instance, obtaining multiple 2D images 310 from the 3D mesh (e.g., 3D model 305) may result in comprehensive coverage for various object in the scene, but may, in some cases, result in conflicts with different labels assigned to a same object in different images. For example, the multiple 2D images 310 may be obtained that capture the entire scene size, as a single image (or a few images) may not be able to capture the entire 3D model 305. As such, a same area of the 3D model 305 may be labeled differently by different 2D images 310. Further, it may be possible that some regions may be unlabeled if not covered well by any virtual camera.

To resolve conflicts with labels, one or more techniques, such as majority-based voting techniques may be utilized. As an example, one or more ML algorithms may determine a final label for a data point (such as an element of a 3D mesh) by taking the most frequent label assigned to the data point (e.g., assigned by the semantic segmentation of the 2D images, assigned by different labeling sources or algorithms), which may determine a “majority vote” among the potential labels. In such examples, each mesh element (e.g., triangle) gathers all labels assigned via raycasting (e.g., backprojection operations). For some mesh elements, an “unlabeled” label may be included as a possible label but may be excluded in a final vote count. A label with the highest vote (e.g., excluding “unlabeled”) is assigned to that mesh element. One or more confidence levels of the labels, if available, may also be taken into account (e.g., for weighted voting). In cases of equal votes for one or more labels, either of the top labels may be chosen, or a label based on neighboring mesh labels may be selected, or any combination thereof.

The described techniques may efficiently handle partial and/or incomplete coverage, as object coverage in one image may be complemented by one or more additional views/images. Here, a final label may be robust enough to overcome single-view errors.

In some aspects, the segmentation performed on the 2D images 310 may comprise instance segmentation. That is, while sematic segmentation may be described in various examples, one or more other or additional segmentation techniques may be performed, and such examples should not be considered limiting to the scope of the claims or the disclosure. Instance segmentation may be a technique for identifying and outlining boundaries of each object in a digital image. Such techniques may include analyzing each pixel in an image and classifying each pixel into a specific class. Each object may be assigned a unique identifier or label, and a pixel-level mask may be generated for each object.

In some examples, connected component analysis may be performed on a final mesh (e.g., a labeled mesh 320 after backprojection) for the instance segmentation. Connected component analysis may include the detection of connected regions or portions of an image, for example, where pixels may be grouped based on pixel connectivity. Thus, instance segmentation may also be possible with the described techniques by carrying instance information from images to mesh (e.g., from respective image segmentation masks to a segmented 3D mesh).

Merging operations may be performed for labeled meshes 315 from different projections (e.g., corresponding to respective frames). As an example, a set of labeled meshes 315 from respective projections 310 (e.g., a first labeled mesh from a first projection, a second labeled mesh from a second projection, and so forth) may be merged together to generate an output mesh 320 that includes the information from the merged meshes. As an illustrative example, multiple windows may be identified in a 2D image when performing segmentation. In accordance with instance segmentation, each window of the multiple windows may be identified as a separate object and may therefore have a separate mask associated with each window.

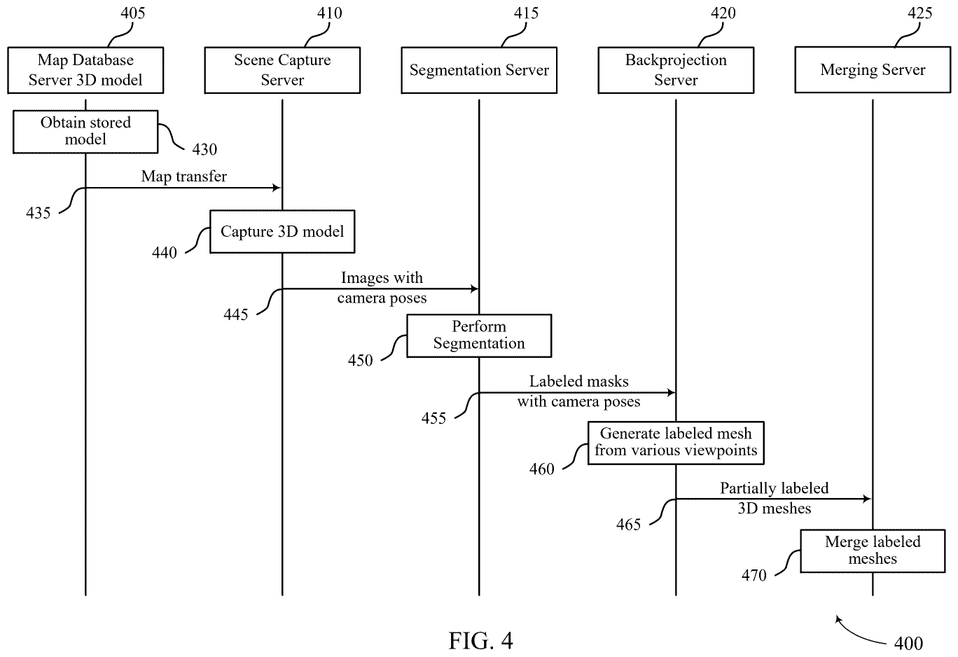

FIG. 4 shows an example of a process flow 400 that supports techniques for segmenting models in accordance with one or more aspects of the present disclosure. The process flow 400 may implement, or be implemented by, one or more aspects of the wireless communications system 100, the computer vision pipeline 200, and/or the 3D segmentation process 300. For example, the process flow 400 may include one or more databases and/or servers, which may be examples of one or more of the devices described with reference to FIG. 1. For instance, the process flow 400 may include a map database server 3D model 405, a scene capture server 410, a segmentation server 415, a backprojection server 420, and a merging server 425.

In the following description of the process flow 400, the operations between the servers and database (e.g., between the map database server 3D model 405, the scene capture server 410, the segmentation server 415, the backprojection server 420, and/or the merging server 425) may be communicated in a different order than the example order shown, or the operations performed by the databases and/or servers may be performed in different orders or at different times. Some operations may also be omitted from the process flow 400, and other operations may be added to the process flow 400. Further, as described herein, aspects of the functions performed by one or more of the databases and/or servers may additionally, or alternatively, be performed by one or more other devices.

In some cases, one or more steps of the computer vision pipeline may be performed by one or more servers (e.g., dedicated servers). As an example, each step may be performed in a respective dedicated server. Such techniques may enable parallel and/or distributed processing for large-scale data. The computer vision pipeline described herein may be modular, allowing for each module to be executed on different dedicated servers, which may enhance both efficiency and scalability during deployment. In some aspects, each phase of the pipeline may operate sequentially and may be executed in a pipeline manner, resulting in increased efficiency and speed.

As an illustrative example, initially, the model may be stored on a database server, and at 430 the map database server 3D model may accordingly obtain the stored unsegmented mesh. At 435, the model may be transmitted to the scene capture server 410 and, at 440, the scene capture server 410 may capture the 3D model. At 445, the scene capture server 410 may send the acquired images along with corresponding camera poses to the segmentation server 415. The segmentation server 415 may conduct segmentation at 450 (e.g., semantic segmentation), and at 455 the segmentation server 415 may forward the labeled masks along with camera poses to the backprojection server 420. The backprojection server 420 may create the labeled mesh at 460. At 465, the backprojection server 420 may send several labeled (e.g., partially labeled) 3D meshes to the merging server 425. At 470, the merging server 425 may merge the labeled meshes, and the combined (e.g., merged) model may represent the final output of a segmented labeled mesh model.

In some aspects, respective servers may perform respective steps of the computer vision pipeline described herein, or one server may perform multiple steps of the computer vision pipeline described herein, or any combination thereof. For example, generating 2D images and generating the segmentation masks may be performed by one server, and one or more other steps may be performed by some quantity of other servers (e.g., dedicated servers). In other examples, one or more respective servers may perform one or more of the features of the computer vision pipeline, one or more subsets of the features of the computer vision pipeline, or any combination thereof. Various combinations may be possible. The described techniques may be scalable for every scene and/or model and may further be used to label each mesh triangle of the scenes. Moreover, the described techniques may be used continuously and/or periodically to perform and/or update the labels, such as in case of updates to a digital twin, among other examples.

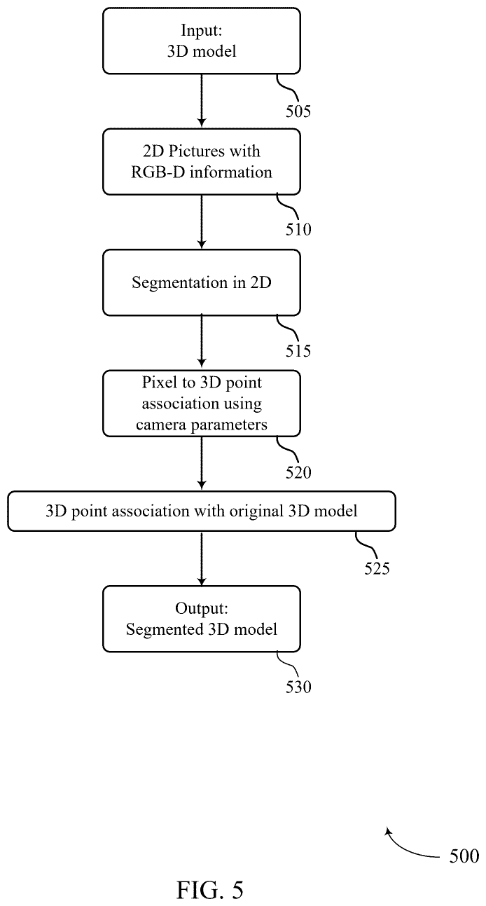

FIG. 5 shows an example of a flowchart 500 that supports techniques for segmenting models in accordance with one or more aspects of the present disclosure. The flowchart 500 may implement, or be implemented by, one or more aspects of the wireless communications system 100, the computer vision pipeline 200, the 3D segmentation process 300, and/or the process flow 400. For example, the flowchart 500 may be associated with one or more databases and/or servers, which may be examples of one or more of the devices described with reference to FIG. 1. Further, the flowchart 500 may implement one or more aspects of the computer vision pipeline 200 and/or the 3D segmentation process 300, as described with reference to FIGS. 2 and 3, respectively.

In the following description of the flowchart 500, the operations between the servers and database may be communicated in a different order than the example order shown, or the operations performed by the databases and/or servers may be performed in different orders or at different times. Some operations may also be omitted from the flowchart 500, and other operations may be added to the flowchart 500. Further, as described herein, aspects of the functions performed by one or more of the databases and/or servers may additionally, or alternatively, be performed by one or more other devices.

In some cases, datasets and techniques for 3D segmentation (e.g., semantic segmentation) may utilize point clouds with data captured from cameras and depth sensors (e.g., LiDAR, stereo cameras, and the like). Various algorithms may accordingly be used to segment a 3D scene associated with a point cloud, including a segment anything 3D (SAM3D) model, among other examples, which may transfer segmentation information of 2D images to 3D space. Such models may use a SAM along with color and depth information (e.g., red, green, blue and depth (RGB-D) information) input from multiple cameras and LiDAR sources. In some examples, relatively large-scale outdoor 3D models (e.g., models capturing outdoor scenes) may be represented in the mesh/surface format (such as, for example, 3D scenes from vendors such as Google).

Further, the application of point cloud 3D semantic segmentation techniques to a 3D mesh model may require that the 3D mesh model first be converted to a point cloud. However, wireless raytracing techniques may, in some cases, require surfaces/meshes associated with the 3D mesh model to similar reflection and/or refraction and other interactions associated with wireless communications by various wireless communication devices (such as UEs and/or network entities, among other examples). As a result, the conversion of point clouds back to mesh format (e.g., using techniques such as Poisson reconstruction) may result in inaccurate surface representations. That is, converting a 3D mesh model to a point cloud for semantic segmentation, and then converting the point cloud back to the 3D mesh may result in inaccuracies that affect the quality and accuracy of a 3D model (e.g., a digital twin), thereby preventing accurate and robust simulations, such as for mapping RF properties for an environment/scene.

In some aspects, segmentation of a 3D mesh may be performed based on associations between points in a reconstructed 3D model (e.g., after segmentation) with meshes of an original 3D model. The described techniques may be used instead of conversion from a mesh format to a point cloud for the purpose of semantic segmentation, and then converting back to the mesh format, which may achieve improved accuracy in surface representation for the final segmented 3D model. As an example, a mesh model may be converted to a point cloud, and one or more point cloud semantic segmentation techniques may be applied to segment the point cloud. Then, an association may be formed between each point in the reconstructed 3D model with a mesh in the original 3D model. The associated may be based on, for example, a nearest corresponding mesh surface to the point, voxelization of each point, followed by the mesh with a highest intersection over union (IoU) (e.g., a metric that measures how well a bounding box may match a location of an object), RGB information, or any combination thereof. In such cases, because the point cloud to mesh association is performed on the original mesh, the described techniques may prevent accuracy loss due to mesh reconstruction. Additionally, such techniques may enable improved accuracy for ray tracing.

In some examples of 3D segmentation, a 3D point cloud model may be used as an input, 2D pictures with RGB-D information may be obtained, segmentation of the 2D pictures may be performed, pixel to point association may be performed using camera parameters, and an output may be a segmented 3D point cloud model. In some other examples, a 3D mesh model may be used as an input, 2D pictures with RGB-D information may be obtained, segmentation of the 2D pictures may be performed, pixel to point association may be performed using camera parameters, segmented point clouds may be converted to meshes, and the output may be a segmented 3D mesh model.

In accordance with the techniques described herein, at 505, the 3D mesh model may be used as an input and, at 510, 2D pictures with RGB-D information may be obtained. At 515, segmentation of the 2D pictures may be performed, at 520, pixel to point association may be performed using camera parameters, and at 525, associations may be identified between 3D points and the original 3D mesh. At 530, the output may be a segmented 3D mesh model with relatively improved accuracy.

As an example, M 2D frames may be obtained from the 3D model (e.g., an unsegmented 3D mesh model) via a camera scan using virtual cameras (510). Such processes may result in M unsegmented frames (e.g., camera frame 1, camera frame 2, through camera frame M), which may be associated with some RGB-D information. Each of the M frames may be associated with respective camera parameters (e.g., camera frame 1 may have one or more virtual camera parameters 1, camera frame 2 may have one or more virtual camera parameters 2, and camera frame M may have one or more virtual camera parameters N, and so forth). In such cases, the 3D model may be opened, and multiple vantage locations may be identified, and virtual cameras may be added to the 3D scene based on the identified vantage locations. The M 2D frames of the entire scene may be obtained by iterating over intrinsic camera parameters (e.g., focal length, field of view (FOV)) and extrinsic camera parameters (e.g., location, orientation). Depth information may also be captured. In one example, a grayscale depth map may be obtained for one or more camera perspectives.

Using the M unsegmented 2D frames (and one or more set of parameters associated with each frame), segmentation (e.g., sematic segmentation, for example, using SAM), as set of M segmented 2D frames (e.g., associated with RGB-D information and respective image segmentation masks) may be generated (515). That is, SAM-2D may be run on each RGB image frame to obtain M segmented 2D frames. Each of the segmented 2D frames may be associated with corresponding camera parameters (e.g., a first segmented frame may be associated with camera parameter 1, a second segmented frame may be associated with camera parameter 2, an Mth segmented frame may be associated with camera parameter N, and so forth).

In some techniques (e.g., that convert segmented point clouds to meshes instead of finding associations between points and the original 3D mesh), the multiple 2D images (e.g., frames) may be converted to a 3D point cloud (e.g., a reconstructed point cloud), where the M segmented 2D frames (e.g., including respective RGB-D information and masks and/or respective sets of camera parameters) may be used to generate M segmented 3D point clouds having the corresponding RGB-D information and masks. In such cases, the 2D masks may be mapped to a 3D space according to the depth of each pixel provided by the RGB-D information of an image. Such techniques (e.g., in accordance with a SAM-3D model) may utilize Equation 1:

$${[ {x}_{i} , {y}_{i} , {z}_{i} ]}^{T} = {R}^{- 1} {M}^{- 1} {s [ {u}_{i} , {v}_{i} , 1 ]}^{T} - {R}^{- 1} T \qquad ( 1 )$$

where s is a scaling between camera and world coordinates, x, y, z are respective world coordinates, u, v are 2D coordinates in the image plane (camera extrinsic), m is a camera intrinsic matrix (e.g., from one or more camera parameters), R, T is a rotation and translation, respectively, from world coordinates to image plane (e.g., from one or more camera parameters). In such cases, [u, v], R, t, M, and s may be used to solve for [x, y, z].

Additionally, or alternatively, some techniques (e.g., in accordance with an Open-SV model) may enable distortion-free projective transformations of a pinhole camera model, and may utilize Equation 2:

$$sp = A [ R \vert t ] {P}_{w} \qquad ( 2 )$$

where, s is a scalar scaling factor between world co-ordinates and an image, p is 2D coordinates in the image plane (camera extrinsic), A is a camera intrinsic matrix (which may also be called M), R, t is a rotation and translation, respectively, from world coordinates to image plane, and P_{w} is a 3D point coordinate. In such cases, s, p, A, R, and t may be used to solve for P_{w}. In some examples, the point clouds may overlap based on overlapping frames.

In accordance with the described techniques, however, the information from the point clouds may be transferred to the mesh domain based on an association (such as shown at 525). For example, a 3D point cloud having K segments may be used to generate 3D meshes with K segments and, for each point in the reconstructed 3D model (e.g., the 3D point cloud), an association between the point and a mesh in the original 3D model may be determined (e.g., identified).

In one example, an application programming interface (API) (e.g., such as an API associated with one or more creation suites for creating 3D visualizations and/or video editing, among other examples) may be used to create one or more data tree structures (such as a bounding volume hierarchy (BVH) tree, among other examples) from all of the meshes in the original 3D scene. Here, for each point in the point cloud that is output from the previous step, an algorithm (such as bvh_tree.find_nearest (Vector (point))) to identify the nearest mesh(es) and distance from the mesh(es) (e.g., a distance between a respective point to a mesh). In some examples, one or more thresholds in accordance with thresholding techniques may be applied to drop (e.g., exclude) points outside of the one or more thresholds. In such cases, different threshold values may be used and fine-tuned based on a local point cloud resolution, mesh resolution, scene complexity, or the like. In some aspects, a one-to-many relationship may be generated between the point cloud and the mesh with a point-mesh distance serving as the means of calculating a probabilistic association between one point and one mesh. Segmentation information of the point cloud may be transferred (e.g., carried over) to the mesh domain when performing such operations. Further, each mesh aggregates the segment information distribution based on the points associated with that mesh, thus creating a 3D segmented mesh (such as shown at 530).

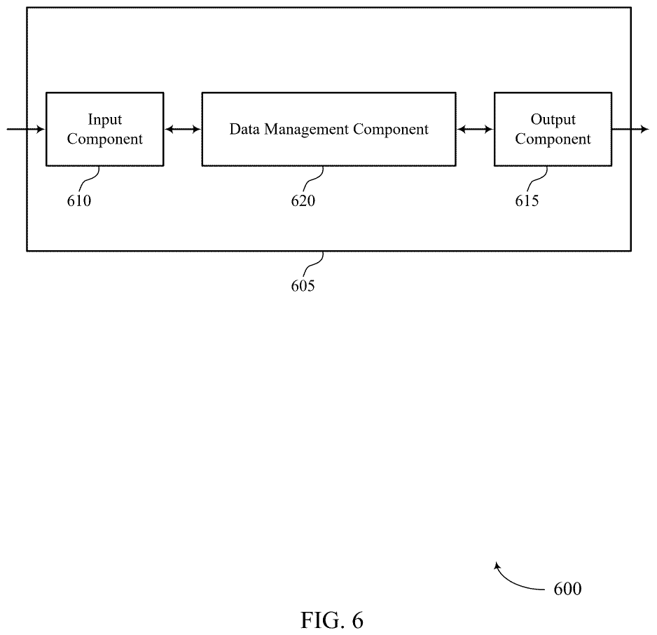

FIG. 6 shows a block diagram 600 of a device 605 that supports techniques for segmenting models in accordance with one or more aspects of the present disclosure. The device 605 may be an example of aspects of a computing device, a UE 115, or a network entity 105 as described herein. The device 605 may include an input component 610, an output component 615, and a data management component 620. The device 605, or one or more components of the device 605 (e.g., the input component 610, the output component 615, the data management component 620), may include at least one processor, which may be coupled with at least one memory, to, individually or collectively, support or enable the described techniques. Each of these components may be in communication with one another (e.g., via one or more buses).

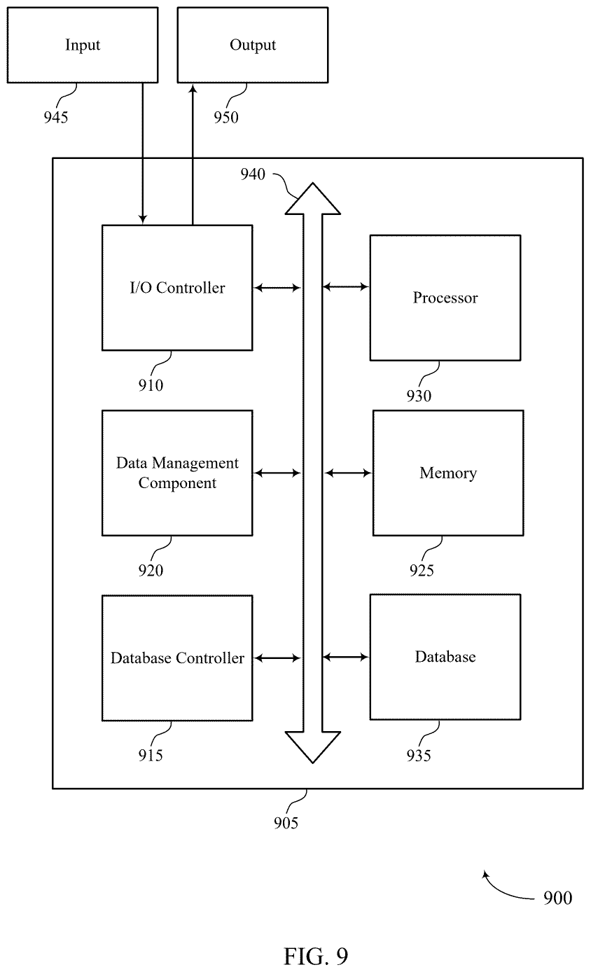

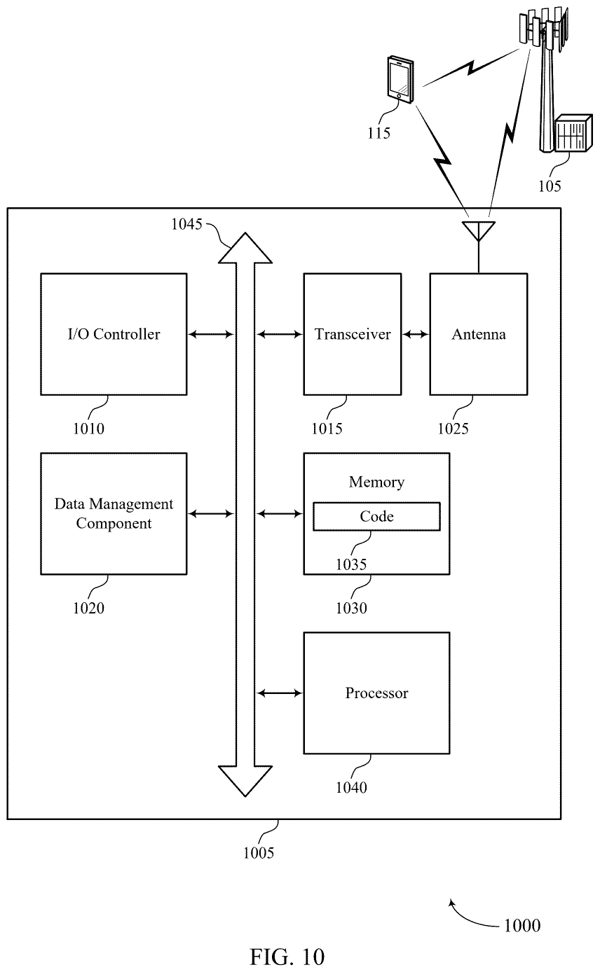

The input component 610 may manage input signals for the device 605. For example, the input component 610 may identify input signals based on an interaction with a modem, a keyboard, a mouse, a touchscreen, or a similar device. These input signals may be associated with user input or processing at other components or devices. In some cases, the input component 610 may utilize an operating system such as iOS®, ANDROID®, MS-DOS®, MS-WINDOWS®, OS/2®, UNIX®, LINUX®, or another known operating system to handle input signals. The input component 610 may send aspects of these input signals to other components of the device 605 for processing. For example, the input component 610 may transmit input signals to the data management component 620 to support techniques for segmenting models. In some cases, the input component 610 may be a component of an input/output (I/O) controller 910 or 1010, such as described with reference to FIGS. 9 and 10.

The output component 615 may manage output signals for the device 605. For example, the output component 615 may receive signals from other components of the device 605, such as the data management component 620, and may transmit these signals to other components or devices. In some specific examples, the output component 615 may transmit output signals for display in a user interface, for storage in a database or data store, for further processing at a server or server cluster, or for any other processes at any quantity of devices or systems. In some cases, the output component 615 may be a component of an I/O controller 910 or 1010, such as described with reference to FIGS. 9 and 10.

The data management component 620, the input component 610, the output component 615, or various combinations or components thereof may be examples of means for performing various aspects of techniques for segmenting models as described herein. For example, the data management component 620, the input component 610, the output component 615, or various combinations or components thereof may be capable of performing one or more of the functions described herein.

In some examples, the data management component 620, the input component 610, the output component 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the data management component 620, the input component 610, the output component 615, or various combinations or components thereof may be implemented in code (e.g., as communications management software or firmware) executed by at least one processor (e.g., referred to as a processor-executable code). If implemented in code executed by at least one processor, the functions of the data management component 620, the input component 610, the output component 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the data management component 620 may be configured to perform various operations (e.g., receiving, obtaining, monitoring, outputting, transmitting) using or otherwise in cooperation with the input component 610, the output component 615, or both. For example, the data management component 620 may receive information from the input component 610, send information to the output component 615, or be integrated in combination with the input component 610, the output component 615, or both to obtain information, output information, or perform various other operations as described herein.

For example, the data management component 620 is capable of, configured to, or operable to support a means for obtaining a set of multiple two-dimensional images from a three-dimensional model. The data management component 620 is capable of, configured to, or operable to support a means for generating a set of multiple image segmentation masks based on one or more segmentation operations performed on each two-dimensional image of the set of multiple two-dimensional images, where respective objects of the set of multiple image segmentation masks are assigned one or more labels. The data management component 620 is capable of, configured to, or operable to support a means for performing backprojection operations for each image segmentation mask of the set of multiple image segmentation masks, where a correspondence between respective pixels in each image segmentation mask and respective objects of the three-dimensional model (e.g., the original three-dimensional model) is identified in accordance with the backprojection operations. The data management component 620 is capable of, configured to, or operable to support a means for merging sets of the one or more labels from each image segmentation mask of the set of multiple image segmentation masks based on the correspondence, where the respective objects of the three-dimensional model are associated with a label in accordance with the merging. The data management component 620 is capable of, configured to, or operable to support a means for generating a segmented three-dimensional model that corresponds to the three-dimensional model, the segmented three-dimensional model including the respective objects of the three-dimensional model having an associated label.

By including or configuring the data management component 620 in accordance with examples as described herein, the device 605 (e.g., at least one processor controlling or otherwise coupled with the input component 610, the output component 615, the data management component 620, or a combination thereof) may support techniques for improved accuracy of visual data models, as well as algorithms that may be applied to various types of 3D data models.

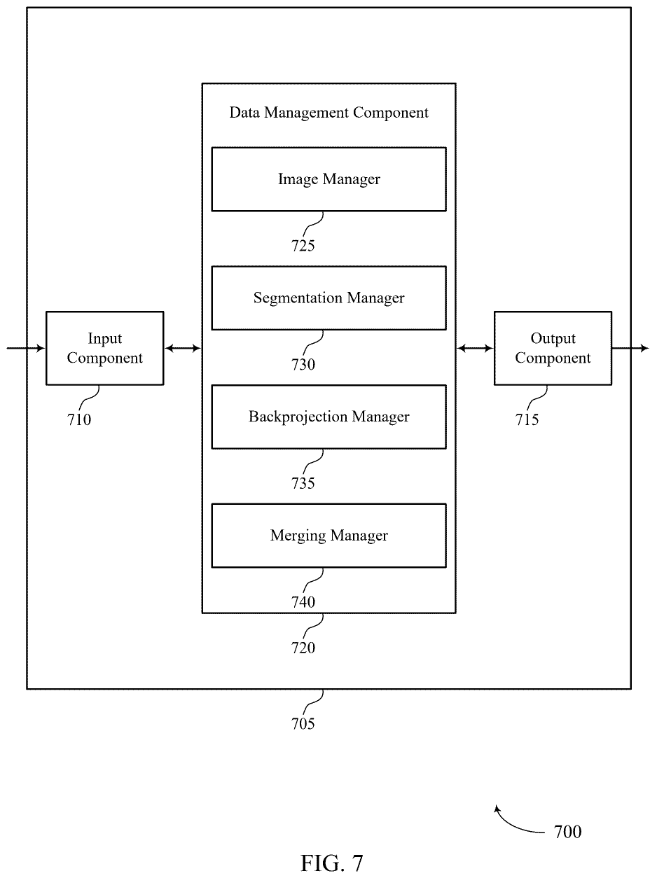

FIG. 7 shows a block diagram 700 of a device 705 that supports techniques for segmenting models in accordance with one or more aspects of the present disclosure. The device 705 may be an example of aspects of a device 605, a computing device, a UE 115, or a network entity 105 as described herein. The device 705 may include an input component 710, an output component 715, and a data management component 720. The device 705, or one or more components of the device 705 (e.g., the input component 710, the output component 715, the data management component 720), may include at least one processor, which may be coupled with at least one memory, to support the described techniques. Each of these components may be in communication with one another (e.g., via one or more buses).

The input component 710 may manage input signals for the device 705. For example, the input component 710 may identify input signals based on an interaction with a modem, a keyboard, a mouse, a touchscreen, or a similar device. These input signals may be associated with user input or processing at other components or devices. In some cases, the input component 710 may utilize an operating system such as iOS®, ANDROID®, MS-DOS®, MS-WINDOWS®, OS/2®, UNIX®, LINUX®, or another known operating system to handle input signals. The input component 710 may send aspects of these input signals to other components of the device 705 for processing. For example, the input component 710 may transmit input signals to the data management component 720 to support techniques for segmenting models. In some cases, the input component 710 may be a component of an I/O controller 910 or 1010, such as described with reference to FIGS. 9 and 10.

The output component 715 may manage output signals for the device 705. For example, the output component 715 may receive signals from other components of the device 705, such as the data management component 720, and may transmit these signals to other components or devices. In some specific examples, the output component 715 may transmit output signals for display in a user interface, for storage in a database or data store, for further processing at a server or server cluster, or for any other processes at any quantity of devices or systems. In some cases, the output component 715 may be a component of an I/O controller 910 or 1010, such as described with reference to FIGS. 9 and 10.

The device 705, or various components thereof, may be an example of means for performing various aspects of techniques for segmenting models as described herein. For example, the data management component 720 may include an image manager 725, a segmentation manager 730, a backprojection manager 735, a merging manager 740, or any combination thereof. The data management component 720 may be an example of aspects of a data management component 620 as described herein. In some examples, the data management component 720, or various components thereof, may be configured to perform various operations (e.g., receiving, obtaining, monitoring, outputting, transmitting) using or otherwise in cooperation with the input component 710, the output component 715, or both. For example, the data management component 720 may receive information from the input component 710, send information to the output component 715, or be integrated in combination with the input component 710, the output component 715, or both to obtain information, output information, or perform various other operations as described herein.

The image manager 725 is capable of, configured to, or operable to support a means for obtaining a set of multiple two-dimensional images from a three-dimensional model. The segmentation manager 730 is capable of, configured to, or operable to support a means for generating a set of multiple image segmentation masks based on one or more segmentation operations performed on each two-dimensional image of the set of multiple two-dimensional images, where respective objects of the set of multiple image segmentation masks are assigned one or more labels. The backprojection manager 735 is capable of, configured to, or operable to support a means for performing backprojection operations for each image segmentation mask of the set of multiple image segmentation masks, where a correspondence between respective pixels in each image segmentation mask and respective objects of the three-dimensional model is identified in accordance with the backprojection operations. The merging manager 740 is capable of, configured to, or operable to support a means for merging sets of the one or more labels from each image segmentation mask of the set of multiple image segmentation masks based on the correspondence, where the respective objects of the three-dimensional model are associated with a label in accordance with the merging. The segmentation manager 730 is capable of, configured to, or operable to support a means for generating a segmented three-dimensional model that corresponds to the three-dimensional model, the segmented three-dimensional model including the respective objects of the three-dimensional model having an associated label.

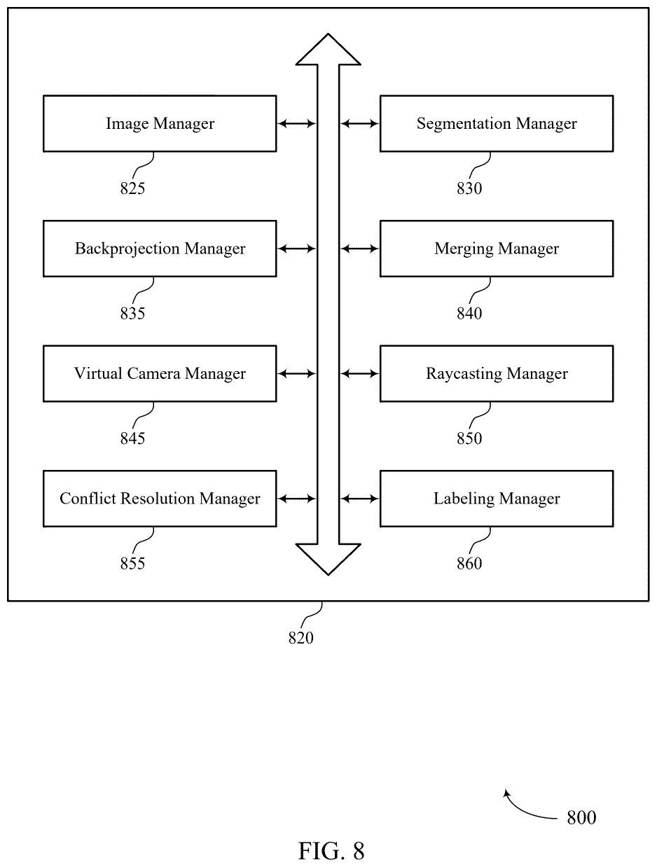

FIG. 8 shows a block diagram 800 of a data management component 820 that supports techniques for segmenting models in accordance with one or more aspects of the present disclosure. The data management component 820 may be an example of aspects of a data management component 620, a data management component 720, or both, as described herein. The data management component 820, or various components thereof, may be an example of means for performing various aspects of techniques for segmenting models as described herein. For example, the data management component 820 may include an image manager 825, a segmentation manager 830, a backprojection manager 835, a merging manager 840, a virtual camera manager 845, a raycasting manager 850, a conflict resolution manager 855, a labeling manager 860, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The image manager 825 is capable of, configured to, or operable to support a means for obtaining a set of multiple two-dimensional images from a three-dimensional model. The segmentation manager 830 is capable of, configured to, or operable to support a means for generating a set of multiple image segmentation masks based on one or more segmentation operations performed on each two-dimensional image of the set of multiple two-dimensional images, where respective objects of the set of multiple image segmentation masks are assigned one or more labels. The backprojection manager 835 is capable of, configured to, or operable to support a means for performing backprojection operations for each image segmentation mask of the set of multiple image segmentation masks, where a correspondence between respective pixels in each image segmentation mask and respective objects of the three-dimensional model is identified in accordance with the backprojection operations. The merging manager 840 is capable of, configured to, or operable to support a means for merging sets of the one or more labels from each image segmentation mask of the set of multiple image segmentation masks based on the correspondence, where the respective objects of the three-dimensional model are associated with a label in accordance with the merging. In some examples, the segmentation manager 830 is capable of, configured to, or operable to support a means for generating a segmented three-dimensional model that corresponds to the three-dimensional model, the segmented three-dimensional model including the respective objects of the three-dimensional model having an associated label.

In some examples, the segmentation manager 830 is capable of, configured to, or operable to support a means for generating a segmented three-dimensional point cloud based on a set of associations between the respective pixels in each image segmentation mask and respective points of the segmented three-dimensional point cloud, the segmented three-dimensional point cloud corresponding to the three-dimensional model, where the set of associations is based on respective sets of parameters associated with each virtual camera of a set of multiple virtual cameras, and where the segmented three-dimensional model is based on associations between the respective points of the segmented three-dimensional point cloud and respective meshes of the three-dimensional model.

In some examples, the associations between the respective points of the segmented three-dimensional point cloud and the respective meshes of the three-dimensional model are determined in accordance with one or more threshold distances between the respective points and the respective meshes, in accordance with one or more voxelization procedures on the respective points and intersection-over-union information for the respective meshes, in accordance with color information for the respective points and the respective meshes, or any combination thereof.

In some examples, to support obtaining the set of multiple two-dimensional images, the virtual camera manager 845 is capable of, configured to, or operable to support a means for capturing the set of multiple two-dimensional images using a set of multiple virtual cameras and based on respective sets of parameters associated with each virtual camera of the set of multiple virtual cameras.

In some examples, to support performing the backprojection operations, the raycasting manager 850 is capable of, configured to, or operable to support a means for performing the backprojection operations using raycasting for the respective pixels in each image segmentation mask, where the correspondence is based on an intersection between a respective object of the three-dimensional model and a ray associated with a pixel in accordance with the raycasting. In some examples, to support performing the backprojection operations, the segmentation manager 830 is capable of, configured to, or operable to support a means for identifying a set of multiple segments of the segmented three-dimensional model based on the raycasting and one or more image masks that are each associated with a respective image segmentation mask of the set of multiple image segmentation masks.

In some examples, the labeling manager 860 is capable of, configured to, or operable to support a means for assigning a label from each object of an image segmentation mask to a corresponding object of the three-dimensional model based on the correspondence.

In some examples, the conflict resolution manager 855 is capable of, configured to, or operable to support a means for resolving, for each object of the three-dimensional model, one or more conflicts between respective labels of the one or more labels after merging the sets of the one or more labels, where the resolving is based on one or more votes for the respective labels.

In some examples, a first server is associated with the generating the set of multiple two-dimensional images, a second server is associated with the generating the set of multiple image segmentation masks, a third server is associated with the performing the backprojection operations, a fourth server is associated with the merging the sets of the one or more labels, and a fifth server is associated with the generating the segmented three-dimensional model, or any combination thereof, is associated with one or more servers.

In some examples, the segmentation manager 830 is capable of, configured to, or operable to support a means for performing the one or more segmentation operations on each two-dimensional image, where the respective objects of the set of multiple image segmentation masks are identified based on one or more object detection models, and where a respective image segmentation mask of the set of multiple image segmentation masks is based on identifying the respective objects.

In some examples, the one or more segmentation operations include instance segmentation based on respective instance information associated with each two-dimensional image that is applied to the segmented three-dimensional model.

FIG. 9 shows a diagram of a system 900 including a device 905 that supports techniques for segmenting models in accordance with one or more aspects of the present disclosure. The device 905 may be an example of or include components of a device 605, a device 705, or a computing device as described herein. The device 905 may include components for bi-directional voice and data communications including components for transmitting and receiving communications, such as a data management component 920, an I/O controller, such as an I/O controller 910, a database controller 915, at least one memory 925, at least one processor 930, and a database 935. These components may be in electronic communication or otherwise coupled (e.g., operatively, communicatively, functionally, electronically, electrically) via one or more buses (e.g., a bus 940).

The I/O controller 910 may manage input signals 945 and output signals 950 for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor. In some examples, a user may interact with the device 905 via the I/O controller 910 or via hardware components controlled by the I/O controller 910.

The database controller 915 may manage data storage and processing in a database 935. The database 935 may be external to the device 905, temporarily or permanently connected to the device 905, or a data storage component of the device 905. In some cases, a user may interact with the database controller 915. In some other cases, the database controller 915 may operate automatically without user interaction. The database 935 may be an example of a persistent data store, a single database, a distributed database, multiple distributed databases, a database management system, or an emergency backup database.

Memory 925 may include random-access memory (RAM) and read-only memory (ROM). The memory 925 may store computer-readable, computer-executable software including instructions that, when executed, cause the processor to perform various functions described herein. In some cases, the memory 925 may contain, among other things, a basic I/O system (BIOS) which may control basic hardware or software operation such as the interaction with peripheral components or devices.

The processor 930 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 930 may be configured to operate a memory array using a memory controller. In some other cases, a memory controller may be integrated into the processor 930. The processor 930 may be configured to execute computer-readable instructions stored in memory 925 to perform various functions (e.g., functions or tasks supporting techniques for segmenting models).

For example, the data management component 920 is capable of, configured to, or operable to support a means for obtaining a set of multiple two-dimensional images from a three-dimensional model. The data management component 920 is capable of, configured to, or operable to support a means for generating a set of multiple image segmentation masks based on one or more segmentation operations performed on each two-dimensional image of the set of multiple two-dimensional images, where respective objects of the set of multiple image segmentation masks are assigned one or more labels. The data management component 920 is capable of, configured to, or operable to support a means for performing backprojection operations for each image segmentation mask of the set of multiple image segmentation masks, where a correspondence between respective pixels in each image segmentation mask and respective objects of the three-dimensional model is identified in accordance with the backprojection operations. The data management component 920 is capable of, configured to, or operable to support a means for merging sets of the one or more labels from each image segmentation mask of the set of multiple image segmentation masks based on the correspondence, where the respective objects of the three-dimensional model are associated with a label in accordance with the merging. The data management component 920 is capable of, configured to, or operable to support a means for generating a segmented three-dimensional model that corresponds to the three-dimensional model, the segmented three-dimensional model including the respective objects of the three-dimensional model having an associated label.

By including or configuring the data management component 920 in accordance with examples as described herein, the device 905 may support techniques for flexible and dynamic computer vision pipelines, such that these pipelines in accordance with the described techniques may be both scalable and applicable to various use cases and applications, as well as enabling relatively high-quality dense segments for 3D models of arbitrary shapes and sizes.

FIG. 10 shows a diagram of a system 1000 including a device 1005 that supports techniques for segmenting models in accordance with one or more aspects of the present disclosure. The device 1005 may be an example of or include components of a device 605, a device 705, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a data management component 1020, an I/O controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1145).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter, a receiver, or any combination thereof or component thereof, as described herein.

The at least one memory 1030 may include random access memory (RAM) and ROM. The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a BIOS which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting techniques for segmenting models). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

For example, the data management component 1020 is capable of, configured to, or operable to support a means for obtaining a set of multiple two-dimensional images from a three-dimensional model. The data management component 1020 is capable of, configured to, or operable to support a means for generating a set of multiple image segmentation masks based on one or more segmentation operations performed on each two-dimensional image of the set of multiple two-dimensional images, where respective objects of the set of multiple image segmentation masks are assigned one or more labels. The data management component 1020 is capable of, configured to, or operable to support a means for performing backprojection operations for each image segmentation mask of the set of multiple image segmentation masks, where a correspondence between respective pixels in each image segmentation mask and respective objects of the three-dimensional model is identified in accordance with the backprojection operations. The data management component 1020 is capable of, configured to, or operable to support a means for merging sets of the one or more labels from each image segmentation mask of the set of multiple image segmentation masks based on the correspondence, where the respective objects of the three-dimensional model are associated with a label in accordance with the merging. The data management component 1020 is capable of, configured to, or operable to support a means for generating a segmented three-dimensional model that corresponds to the three-dimensional model, the segmented three-dimensional model including the respective objects of the three-dimensional model having an associated label.

By including or configuring the data management component 1020 in accordance with examples as described herein, the device 1005 may support techniques for flexible and dynamic computer vision pipelines, such that these pipelines in accordance with the described techniques may be both scalable and applicable to various use cases and applications, as well as enabling relatively high-quality dense segments for 3D models of arbitrary shapes and sizes.

In some examples, the data management component 1020 may be configured to perform various operations (e.g., receiving, monitoring, transmitting) using or otherwise in cooperation with the transceiver 1015, the one or more antennas 1025, or any combination thereof. Although the data management component 1020 is illustrated as a separate component, in some examples, one or more functions described with reference to the data management component 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of techniques for segmenting models as described herein, or the at least one processor 1040 and the at least one memory 1030 may be otherwise configured to, individually or collectively, perform or support such operations.

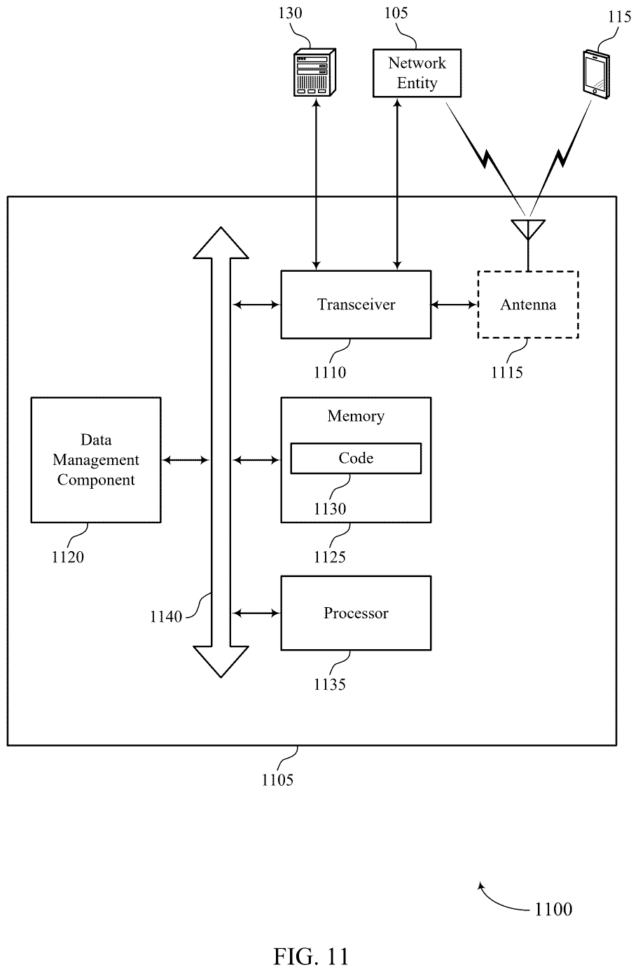

FIG. 11 shows a diagram of a system 1100 including a device 1105 that supports techniques for segmenting models in accordance with one or more aspects of the present disclosure. The device 1105 may be an example of or include components of a device 605, a device 705, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a data management component 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for segmenting models). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the data management component 1120, the transceiver 1110, the at least one memory 1125, the code 1130, and the at least one processor 1135 may be located in one of the different components or divided between different components).

In some examples, the data management component 1120 may manage aspects of communications with a core network 130 (e.g., via one or more wired or wireless backhaul links). For example, the data management component 1120 may manage the transfer of data communications for client devices, such as one or more UEs 115. In some examples, the data management component 1120 may manage communications with one or more other network entities 105, and may include a controller or scheduler for controlling communications with UEs 115 (e.g., in cooperation with the one or more other network devices). In some examples, the data management component 1120 may support an X2 interface within an LTE/LTE-A wireless communications network technology to provide communication between network entities 105.

For example, the data management component 1120 is capable of, configured to, or operable to support a means for obtaining a set of multiple two-dimensional images from a three-dimensional model. The data management component 1120 is capable of, configured to, or operable to support a means for generating a set of multiple image segmentation masks based on one or more segmentation operations performed on each two-dimensional image of the set of multiple two-dimensional images, where respective objects of the set of multiple image segmentation masks are assigned one or more labels. The data management component 1120 is capable of, configured to, or operable to support a means for performing backprojection operations for each image segmentation mask of the set of multiple image segmentation masks, where a correspondence between respective pixels in each image segmentation mask and respective objects of the three-dimensional model is identified in accordance with the backprojection operations. The data management component 1120 is capable of, configured to, or operable to support a means for merging sets of the one or more labels from each image segmentation mask of the set of multiple image segmentation masks based on the correspondence, where the respective objects of the three-dimensional model are associated with a label in accordance with the merging. The data management component 1120 is capable of, configured to, or operable to support a means for generating a segmented three-dimensional model that corresponds to the three-dimensional model, the segmented three-dimensional model including the respective objects of the three-dimensional model having an associated label.

By including or configuring the data management component 1120 in accordance with examples as described herein, the device 1105 may support techniques for flexible and dynamic computer vision pipelines, such that these pipelines in accordance with the described techniques may be both scalable and applicable to various use cases and applications, as well as enabling relatively high-quality dense segments for 3D models of arbitrary shapes and sizes.

In some examples, the data management component 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the data management component 1120 is illustrated as a separate component, in some examples, one or more functions described with reference to the data management component 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for segmenting models as described herein, or the at least one processor 1135 and the at least one memory 1125 may be otherwise configured to, individually or collectively, perform or support such operations.

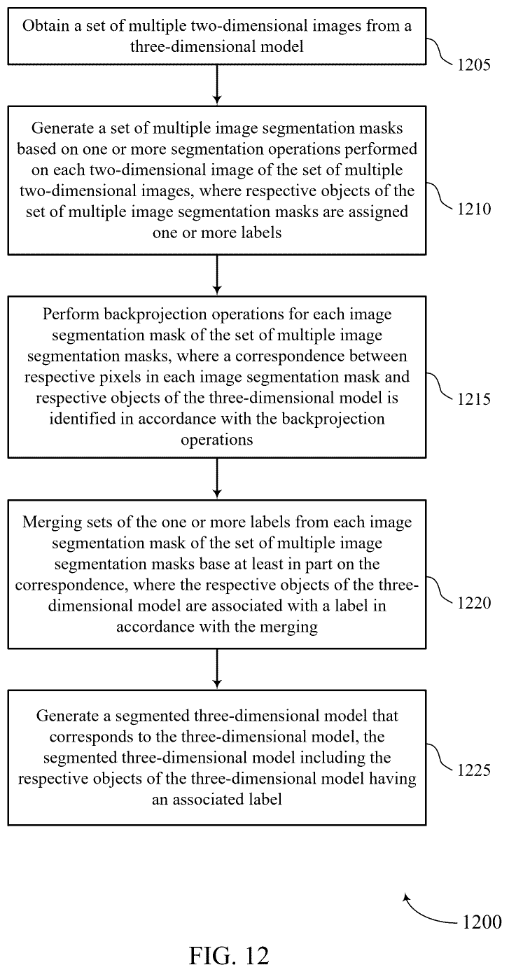

FIG. 12 shows a flowchart illustrating a method 1200 that supports techniques for segmenting models in accordance with one or more aspects of the present disclosure. The operations of the method 1200 may be implemented by a computing device, a UE, or a network entity or its components as described herein. For example, the operations of the method 1200 may be performed by a computing device, a UE 115, or a network entity as described with reference to FIGS. 1 through 11. In some examples, a computing device, a UE, or a network entity may execute a set of instructions to control the functional elements of the computing device, the UE, or the network entity to perform the described functions. Additionally, or alternatively, the computing device, the UE, or the network entity may perform aspects of the described functions using special-purpose hardware.

At 1205, the method may include obtaining a set of multiple two-dimensional images from a three-dimensional model. The operations of 1205 may be performed in accordance with examples as disclosed herein. In some examples, aspects of the operations of 1205 may be performed by an image manager 825 as described with reference to FIG. 8.

At 1210, the method may include generating a set of multiple image segmentation masks based on one or more segmentation operations performed on each two-dimensional image of the set of multiple two-dimensional images, where respective objects of the set of multiple image segmentation masks are assigned one or more labels. The operations of 1210 may be performed in accordance with examples as disclosed herein. In some examples, aspects of the operations of 1210 may be performed by a segmentation manager 830 as described with reference to FIG. 8.

At 1215, the method may include performing backprojection operations for each image segmentation mask of the set of multiple image segmentation masks, where a correspondence between respective pixels in each image segmentation mask and respective objects of the three-dimensional model is identified in accordance with the backprojection operations. The operations of 1215 may be performed in accordance with examples as disclosed herein. In some examples, aspects of the operations of 1215 may be performed by a backprojection manager 835 as described with reference to FIG. 8.

At 1220, the method may include merging sets of the one or more labels from each image segmentation mask of the set of multiple image segmentation masks based on the correspondence, where the respective objects of the three-dimensional model are associated with a label in accordance with the merging. The operations of 1220 may be performed in accordance with examples as disclosed herein. In some examples, aspects of the operations of 1220 may be performed by a merging manager 840 as described with reference to FIG. 8.

At 1225, the method may include generating a segmented three-dimensional model that corresponds to the three-dimensional model, the segmented three-dimensional model including the respective objects of the three-dimensional model having an associated label. The operations of 1225 may be performed in accordance with examples as disclosed herein. In some examples, aspects of the operations of 1225 may be performed by a segmentation manager 830 as described with reference to FIG. 8.

The following provides an overview of aspects of the present disclosure:
Aspect 1: A method, comprising: obtaining a plurality of two-dimensional images from a three-dimensional model; generating a plurality of image segmentation masks based at least in part on one or more segmentation operations performed on each two-dimensional image of the plurality of two-dimensional images, wherein respective objects of the plurality of image segmentation masks are assigned one or more labels; performing backprojection operations for each image segmentation mask of the plurality of image segmentation masks, wherein a correspondence between respective pixels in each image segmentation mask and respective objects of the three-dimensional model is identified in accordance with the backprojection operations; merging sets of the one or more labels from each image segmentation mask of the plurality of image segmentation masks based at least in part on the correspondence, wherein the respective objects of the three-dimensional model are associated with a label in accordance with the merging; and generating a segmented three-dimensional model that corresponds to the three-dimensional model, the segmented three-dimensional model comprising the respective objects of the three-dimensional model having an associated label.
Aspect 2: The method of aspect 1, further comprising: generating a segmented three-dimensional point cloud based at least in part on a set of associations between the respective pixels in each image segmentation mask and respective points of the segmented three-dimensional point cloud, the segmented three-dimensional point cloud corresponding to the three-dimensional model, wherein the set of associations is based at least in part on respective sets of parameters associated with each virtual camera of a plurality of virtual cameras, and wherein the segmented three-dimensional model is based at least in part on associations between the respective points of the segmented three-dimensional point cloud and respective meshes of the three-dimensional model.
Aspect 3: The method of aspect 2, wherein the associations between the respective points of the segmented three-dimensional point cloud and the respective meshes of the three-dimensional model are determined in accordance with one or more threshold distances between the respective points and the respective meshes, in accordance with one or more voxelization procedures on the respective points and intersection-over-union information for the respective meshes, in accordance with color information for the respective points and the respective meshes, or any combination thereof.
Aspect 4: The method of any of aspects 1 through 3, wherein obtaining the plurality of two-dimensional images comprises: capturing the plurality of two-dimensional images using a plurality of virtual cameras and based at least in part on respective sets of parameters associated with each virtual camera of the plurality of virtual cameras.
Aspect 5: The method of any of aspects 1 through 4, wherein performing the backprojection operations comprises: performing the backprojection operations using raycasting for the respective pixels in each image segmentation mask, wherein the correspondence is based at least in part on an intersection between a respective object of the three-dimensional model and a ray associated with a pixel in accordance with the raycasting, the method further comprising: identifying a plurality of segments of the segmented three-dimensional model based at least in part on the raycasting and one or more image masks that are each associated with a respective image segmentation mask of the plurality of image segmentation masks.
Aspect 6: The method of aspect 5, further comprising: assigning a label from each object of an image segmentation mask to a corresponding object of the three-dimensional model based at least in part on the correspondence.
Aspect 7: The method of any of aspects 1 through 6, further comprising: resolving, for each object of the three-dimensional model, one or more conflicts between respective labels of the one or more labels after merging the sets of the one or more labels, wherein the resolving is based at least in part on one or more votes for the respective labels.
Aspect 8: The method of any of aspects 1 through 7, wherein a first server is associated with the generating the plurality of two-dimensional images, a second server is associated with the generating the plurality of image segmentation masks, a third server is associated with the performing the backprojection operations, a fourth server is associated with the merging the sets of the one or more labels, and a fifth server is associated with the generating the segmented three-dimensional model, or any combination thereof, is associated with one or more servers.
Aspect 9: The method of any of aspects 1 through 8, further comprising: performing the one or more segmentation operations on each two-dimensional image, wherein the respective objects of the plurality of image segmentation masks are identified based at least in part on one or more object detection models, and wherein a respective image segmentation mask of the plurality of image segmentation masks is based at least in part on identifying the respective objects.
Aspect 10: The method of any of aspects 1 through 9, wherein the one or more segmentation operations comprise instance segmentation based at least in part on respective instance information associated with each two-dimensional image that is applied to the segmented three-dimensional model.
Aspect 11: An apparatus comprising one or more memories storing processor-executable code, and one or more processors coupled with the one or more memories and individually or collectively operable to execute the code to cause the apparatus to perform a method of any of aspects 1 through 10.
Aspect 12: An apparatus comprising at least one means for performing a method of any of aspects 1 through 10.
Aspect 13: A non-transitory computer-readable medium storing code the code comprising instructions executable by one or more processors to perform a method of any of aspects 1 through 10.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more memories storing processor-executable code; and
one or more processors coupled with the one or more memories and individually or collectively operable to execute the code to cause the apparatus to:
obtain a plurality of two-dimensional images from a three-dimensional model;
generate a plurality of image segmentation masks based at least in part on one or more segmentation operations performed on each two-dimensional image of the plurality of two-dimensional images, wherein respective objects of the plurality of image segmentation masks are assigned one or more labels;
perform backprojection operations for each image segmentation mask of the plurality of image segmentation masks, wherein a correspondence between respective pixels in each image segmentation mask and respective objects of the three-dimensional model is identified in accordance with the backprojection operations;
merging sets of the one or more labels from each image segmentation mask of the plurality of image segmentation masks based at least in part on the correspondence, wherein the respective objects of the three-dimensional model are associated with a label in accordance with the merging; and
generate a segmented three-dimensional model that corresponds to the three-dimensional model, the segmented three-dimensional model comprising the respective objects of the three-dimensional model having an associated label.

2. The apparatus of claim 1, wherein the one or more processors are individually or collectively further operable to execute the code to cause the apparatus to:
generate a segmented three-dimensional point cloud based at least in part on a set of associations between the respective pixels in each image segmentation mask and respective points of the segmented three-dimensional point cloud, the segmented three-dimensional point cloud corresponding to the three-dimensional model, wherein the set of associations is based at least in part on respective sets of parameters associated with each virtual camera of a plurality of virtual cameras, and wherein the segmented three-dimensional model is based at least in part on associations between the respective points of the segmented three-dimensional point cloud and respective meshes of the three-dimensional model.

3. The apparatus of claim 2, wherein the associations between the respective points of the segmented three-dimensional point cloud and the respective meshes of the three-dimensional model are determined in accordance with one or more threshold distances between the respective points and the respective meshes, in accordance with one or more voxelization procedures on the respective points and intersection-over-union information for the respective meshes, in accordance with color information for the respective points and the respective meshes, or any combination thereof.

4. The apparatus of claim 1, wherein, to obtain the plurality of two-dimensional images, the one or more processors are individually or collectively operable to execute the code to cause the apparatus to:
capture the plurality of two-dimensional images using a plurality of virtual cameras and based at least in part on respective sets of parameters associated with each virtual camera of the plurality of virtual cameras.

5. The apparatus of claim 1, wherein, to perform the backprojection operations, the one or more processors are individually or collectively operable to execute the code to cause the apparatus to:
perform the backprojection operations using raycasting for the respective pixels in each image segmentation mask, wherein the correspondence is based at least in part on an intersection between a respective object of the three-dimensional model and a ray associated with a pixel in accordance with the raycasting, wherein the one or more processors are individually or collectively further operable to execute the code to cause the apparatus to:
identify a plurality of segments of the segmented three-dimensional model based at least in part on the raycasting and one or more image masks that are each associated with a respective image segmentation mask of the plurality of image segmentation masks.

6. The apparatus of claim 5, wherein the one or more processors are individually or collectively further operable to execute the code to cause the apparatus to:
assign a label from each object of an image segmentation mask to a corresponding object of the three-dimensional model based at least in part on the correspondence.

7. The apparatus of claim 1, wherein the one or more processors are individually or collectively further operable to execute the code to cause the apparatus to:
resolve, for each object of the three-dimensional model, one or more conflicts between respective labels of the one or more labels after merging the sets of the one or more labels, wherein the resolving is based at least in part on one or more votes for the respective labels.

8. The apparatus of claim 1, wherein a first server is associated with the generating the plurality of two-dimensional images, a second server is associated with the generating the plurality of image segmentation masks, a third server is associated with the performing the backprojection operations, a fourth server is associated with the merging the sets of the one or more labels, and a fifth server is associated with the generating the segmented three-dimensional model, or any combination thereof, is associated with one or more servers.

9. The apparatus of claim 1, wherein the one or more processors are individually or collectively further operable to execute the code to cause the apparatus to:
perform the one or more segmentation operations on each two-dimensional image, wherein the respective objects of the plurality of image segmentation masks are identified based at least in part on one or more object detection models, and wherein a respective image segmentation mask of the plurality of image segmentation masks is based at least in part on identifying the respective objects.

10. The apparatus of claim 1, wherein the one or more segmentation operations comprise instance segmentation based at least in part on respective instance information associated with each two-dimensional image that is applied to the segmented three-dimensional model.

11. A method, comprising:
obtaining a plurality of two-dimensional images from a three-dimensional model;
generating a plurality of image segmentation masks based at least in part on one or more segmentation operations performed on each two-dimensional image of the plurality of two-dimensional images, wherein respective objects of the plurality of image segmentation masks are assigned one or more labels;
performing backprojection operations for each image segmentation mask of the plurality of image segmentation masks, wherein a correspondence between respective pixels in each image segmentation mask and respective objects of the three-dimensional model is identified in accordance with the backprojection operations;
merging sets of the one or more labels from each image segmentation mask of the plurality of image segmentation masks based at least in part on the correspondence, wherein the respective objects of the three-dimensional model are associated with a label in accordance with the merging; and
generating a segmented three-dimensional model that corresponds to the three-dimensional model, the segmented three-dimensional model comprising the respective objects of the three-dimensional model having an associated label.

12. The method of claim 11, further comprising:
generating a segmented three-dimensional point cloud based at least in part on a set of associations between the respective pixels in each image segmentation mask and respective points of the segmented three-dimensional point cloud, the segmented three-dimensional point cloud corresponding to the three-dimensional model, wherein the set of associations is based at least in part on respective sets of parameters associated with each virtual camera of a plurality of virtual cameras, and wherein the segmented three-dimensional model is based at least in part on associations between the respective points of the segmented three-dimensional point cloud and respective meshes of the three-dimensional model.

13. The method of claim 12, wherein the associations between the respective points of the segmented three-dimensional point cloud and the respective meshes of the three-dimensional model are determined in accordance with one or more threshold distances between the respective points and the respective meshes, in accordance with one or more voxelization procedures on the respective points and intersection-over-union information for the respective meshes, in accordance with color information for the respective points and the respective meshes, or any combination thereof.

14. The method of claim 11, wherein obtaining the plurality of two-dimensional images comprises:
capturing the plurality of two-dimensional images using a plurality of virtual cameras and based at least in part on respective sets of parameters associated with each virtual camera of the plurality of virtual cameras.

15. The method of claim 11, wherein performing the backprojection operations comprises:
performing the backprojection operations using raycasting for the respective pixels in each image segmentation mask, wherein the correspondence is based at least in part on an intersection between a respective object of the three-dimensional model and a ray associated with a pixel in accordance with the raycasting, the method further comprising:
identifying a plurality of segments of the segmented three-dimensional model based at least in part on the raycasting and one or more image masks that are each associated with a respective image segmentation mask of the plurality of image segmentation masks.

16. The method of claim 15, further comprising:
assigning a label from each object of an image segmentation mask to a corresponding object of the three-dimensional model based at least in part on the correspondence.

17. The method of claim 11, further comprising:
resolving, for each object of the three-dimensional model, one or more conflicts between respective labels of the one or more labels after merging the sets of the one or more labels, wherein the resolving is based at least in part on one or more votes for the respective labels.

18. The method of claim 11, wherein a first server is associated with the generating the plurality of two-dimensional images, a second server is associated with the generating the plurality of image segmentation masks, a third server is associated with the performing the backprojection operations, a fourth server is associated with the merging the sets of the one or more labels, and a fifth server is associated with the generating the segmented three-dimensional model, or any combination thereof, is associated with one or more servers.

19. The method of claim 11, further comprising:
performing the one or more segmentation operations on each two-dimensional image, wherein the respective objects of the plurality of image segmentation masks are identified based at least in part on one or more object detection models, and wherein a respective image segmentation mask of the plurality of image segmentation masks is based at least in part on identifying the respective objects.

20. A non-transitory computer-readable medium storing code, the code comprising instructions executable by one or more processors to:
obtain a plurality of two-dimensional images from a three-dimensional model;
generate a plurality of image segmentation masks based at least in part on one or more segmentation operations performed on each two-dimensional image of the plurality of two-dimensional images, wherein respective objects of the plurality of image segmentation masks are assigned one or more labels;
perform backprojection operations for each image segmentation mask of the plurality of image segmentation masks, wherein a correspondence between respective pixels in each image segmentation mask and respective objects of the three-dimensional model is identified in accordance with the backprojection operations;
merging sets of the one or more labels from each image segmentation mask of the plurality of image segmentation masks based at least in part on the correspondence, wherein the respective objects of the three-dimensional model are associated with a label in accordance with the merging; and
generate a segmented three-dimensional model that corresponds to the three-dimensional model, the segmented three-dimensional model comprising the respective objects of the three-dimensional model having an associated label.
